(19) United States
(12) Patent Application Publication
(10) Pub. No.: US 2022/0292422 A1
(43) Pub. Date: Sep. 15, 2022

(54) ADVANCED SEARCH ENGINE FOR FEDERAL SPEND AND USER INTERFACE FOR THE SAME

(71) Applicant: Leadership Connect, Inc., New York, NY (US)

(72) Inventors: Stefan Chopin, Weston, CT (US); Michael Crosby, South Orange, NJ (US)

(21) Appl. No.: 17/694,515

(22) Filed: Mar. 14, 2022

Related U.S. Application Data
(60) Provisional application No. 63/161,373, filed on Mar. 15, 2021.

(51) Int. Cl. G06Q 10/06

(52) U.S. Cl. CPC G06Q 10/06313; G06Q 10/063118; G06Q 10/0639

(57) ABSTRACT

Systems and methods applicable, for instance, to federal spend search engines and user interfaces. Data operations can transform and enhance raw federal spend data. Further, users can be presented with information that can be understood and consumed at a glance.

### CROSS-REFERENCE TO RELATED APPLICATIONS

This application claims priority to U.S. Provisional Patent Application Ser. No. 63/161,373, filed on Mar. 15, 2021, the contents of which are incorporated herein by reference in their entirety and for all purposes.

### FIELD OF THE INVENTION

The present technology relates to the field of aiding users in exploiting federal spending data.

### BACKGROUND OF THE INVENTION

Raw federal spending data is typically provided in a flat format, where data regarding contract modification actions, funding actions, initial awarding actions, and other actions is situated at a single level. However, this flat format does not afford users a meaningful view of federal government spending data.

Provided with federal government spending data in this conventional flat format/single level way, as just some examples it can be difficult for users to adopt appropriate viewpoints of federal spending data, perceive interrelationships among various federal spending data elements, and to grasp a complete picture of the entirety of a given federal award process.

As just some additional examples, according to conventional approaches it can be difficult for users to identify bidding opportunities that are appropriate for them, to learn of the corresponding details of these opportunities, and to come to know of competitors who might bid on those opportunities. What is more, these difficulties arising from existing approaches for providing federal spending data can be exacerbated where users lack a full understanding of the structure of federal spending data and the way the federal government classifies awards and opportunities.

As such, there is call for technologies which are applicable to helping users to exploit the full value of federal spending data.

### BRIEF DESCRIPTION OF THE DRAWINGS

FIG. 1A, FIG. 1B, FIG. 1C, and FIG. 1D together show a high-level architecture diagram, according to various embodiments.

FIG. 2 shows a high-level flow diagram, according to various embodiments.

FIG. 3 shows a search/data services user interface (UI), according to various embodiments.

FIG. 4 shows a further search/data services UI, according to various embodiments.

FIG. 5 shows an additional search/data services UI, according to various embodiments.

FIG. 6 shows a UI displaying information about a person, according to various embodiments.

FIG. 7 shows a dashboard UI, according to various embodiments.

FIG. 8A shows a new opportunity search card UI, according to various embodiments.

FIG. 8B shows a further new opportunity search card UI, according to various embodiments.

FIG. 9 shows a nested search UI, according to various embodiments.

FIG. 10 shows a further nested search UI, according to various embodiments.

FIG. 11 shows an expiring award search card UI, according to various embodiments.

FIG. 12 shows a further expiring award search card UI, according to various embodiments.

FIG. 13 shows an additional expiring award search card UI, according to various embodiments.

FIG. 14 shows an additional nested search UI, according to various embodiments.

FIG. 15 shows a UI displaying top influencer information, according to various embodiments.

FIG. 16 shows a top spend informational widget UI, according to various embodiments.

FIG. 17 shows a further top spend informational widget UI, according to various embodiments.

FIG. 18 shows a top awardees informational widget UI, according to various embodiments.

FIG. 19 shows a further top awardees informational widget UI, according to various embodiments.

FIG. 20 shows an awards by state informational widget UI, according to various embodiments.

FIG. 21 shows a track-by-vendor UI, according to various embodiments.

FIG. 22 shows an alerting functionality UI, according to various embodiments.

FIG. 23 shows a saved search UI, according to various embodiments.

FIG. 24 shows a further saved search UI, according to various embodiments.

FIG. 25 shows a contacts list UI, according to various embodiments.

FIG. 26 shows a further contacts list UI, according to various embodiments.

FIG. 27 shows an additional contacts list UI, according to various embodiments.

FIG. 28 shows an advanced search filter UI, according to various embodiments.

FIG. 29 shows an example computer, according to various embodiments.

### DETAILED DESCRIPTION

According to various embodiments, computerized approaches can be used to present federal spending data to users in meaningful ways. As just an example, the computerized approaches discussed herein can present federal spending data to a user such that federal spending actions are grouped together into awards, and the user is presented with a complete picture of the entire award process, including how and when money is actually obligated to be paid out to the winning vendor. As just another example, the computerized approaches discussed herein can present federal spending data to a user such that the user is shown federal spending opportunities as a whole, rather than just individual solicitations. For instance, the user can be presented with the latest information on an opportunity that they might be able to bid for, and can be informed of competitors who might bid on those opportunities. Moreover, the computerized approaches discussed herein can include performing various additional processing on federal spend data, including enhancing government-provided federal spending data with independently-compiled federal staff organizational data (e.g., staff organizational data regarding a relevant awarding office).

The computerized approaches discussed herein can allow a user to request such presentation, and to locate federal spend opportunities and awards, via a variety of search inputs. In this way, benefits, such as allowing a user to find awards and opportunities in absence of an understanding of the structure of federal spending data or the way the federal government classifies awards and opportunities can accrue. Various aspects will now be discussed in greater detail.

### Data Operations

The data operations performed by the system can include a multi-step process wherein the system can transform and enhance raw federal spend data, and can present a user with information that can be understood and consumed at a glance. The process can include the system linking/grouping contracts and solicitations together. Such linking/grouping can, as just one example, allow the contracts and solicitations to be referenced by a known, common identifier, and can allow the system to provide the user with the latest state of an award or opportunity at a glance. For awards/contracts, the system can perform the linking/grouping using a corresponding government-provided award ID. For opportunities/solicitations, the system can perform the linking/grouping using a combination of fields which serves to uniquely identify a set of opportunities/solicitations that should be linked. In some embodiments, a machine learning (ML) approach (e.g., a feature selection ML approach) can be used to select the combination of fields.

The process can further include the system performing additional processing so as to enhance government-provided federal spending data. The enhancement can provide users with extra information about awards and opportunities, thereby making current award and opportunity status easily consumable at a glance. The additional processing can include operations performed with respect to award data, and operations performed with respect to opportunity data. The operations performed with respect to award data can include the system determining what award/contract changes were made over one or more given time periods (e.g., over each fiscal year), determining what the current award/contract dollar amounts are, and ascertaining award/contract modifications (e.g., by analyzing funding transactions). The operations performed with respect to opportunity data can include the system evaluating a current (e.g., most current) solicitation to determine the state of the opportunity. Further still, the additional processing performed by the system can include generating and/or enhancing links between awards and/or opportunities, and independently-compiled federal staff organizational data (sometimes referred to as “LCI,” “LCI orgs,” “LCI data” and similar terms/phrases in the text and figures). The independently-compiled federal staff organizational data can include decision making funding hierarchies of government entities. These decision making hierarchies can regard deep and complex organizational structures of the government entities (e.g., organizational structures with 18 levels). Further, the independently-compiled federal staff organizational data can cover a greater quantity of offices than conventional systems (e.g., encompassing 100× more offices than conventional systems). Additionally, the independently-compiled federal staff organizational data can include richer data for offices than provided by conventional systems (e.g., allowing a user to learn that a federal contract customer has an address of 1522 P Street NW in Washington, D.C., where a conventional system might merely indicate Washington, D.C. as the address for that federal contract customer). Also, the additional processing performed by the system can include providing summaries (e.g., fiscal-year-based summaries) of awards given by federal departments, and performing financial rollups. In this way, the system can give users a more holistic overview of, for example, major department spending (e.g., at the levels of the Department of Defense (DOD) and/or Department of Homeland Security (DHS)).

The data resulting from the multi-step process can be stored, and made available to users upon request. As such, when, for example, a user requests an award or opportunity, the system can provide the user with augmented data that goes beyond the raw federal spend data. As such, the user can receive, as just some examples, detailed information about the federal departments, agencies, and offices that are involved in either publishing an opportunity or awarding a contract. The user can therefore easily move from examining an individual award to finding out more detailed information about the federal offices involved that award, including information about the individuals who work in that office, or other offices that may also have some insight into the award deliverables.

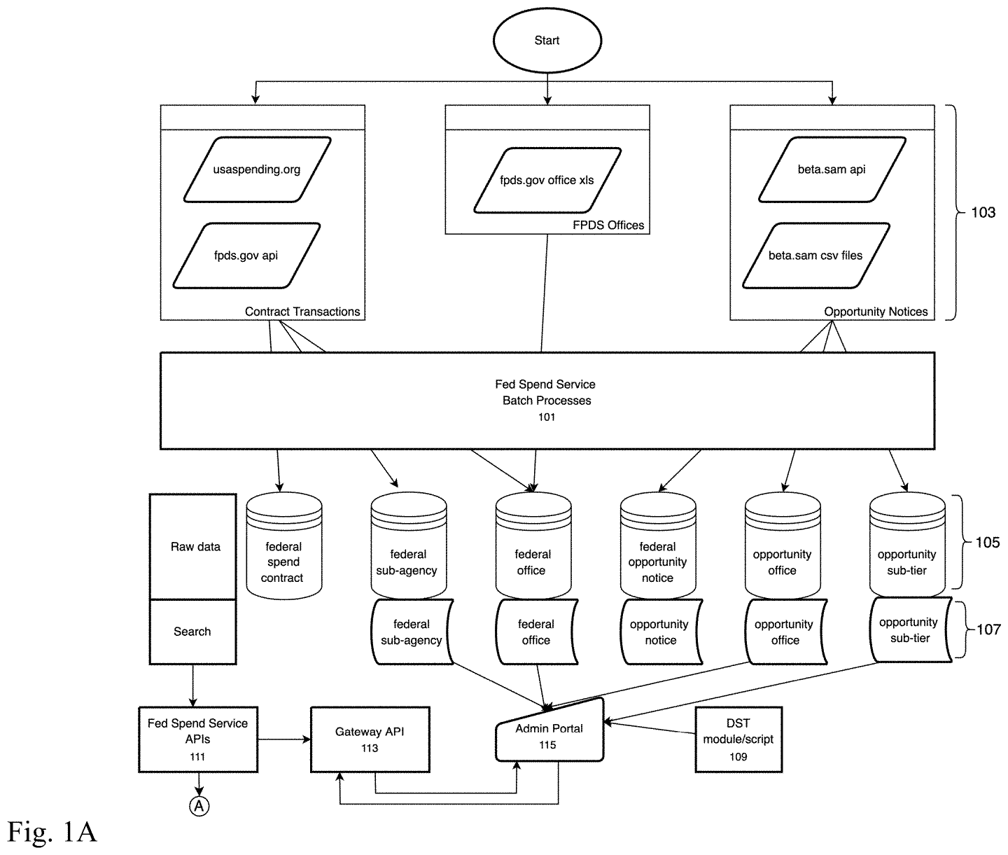

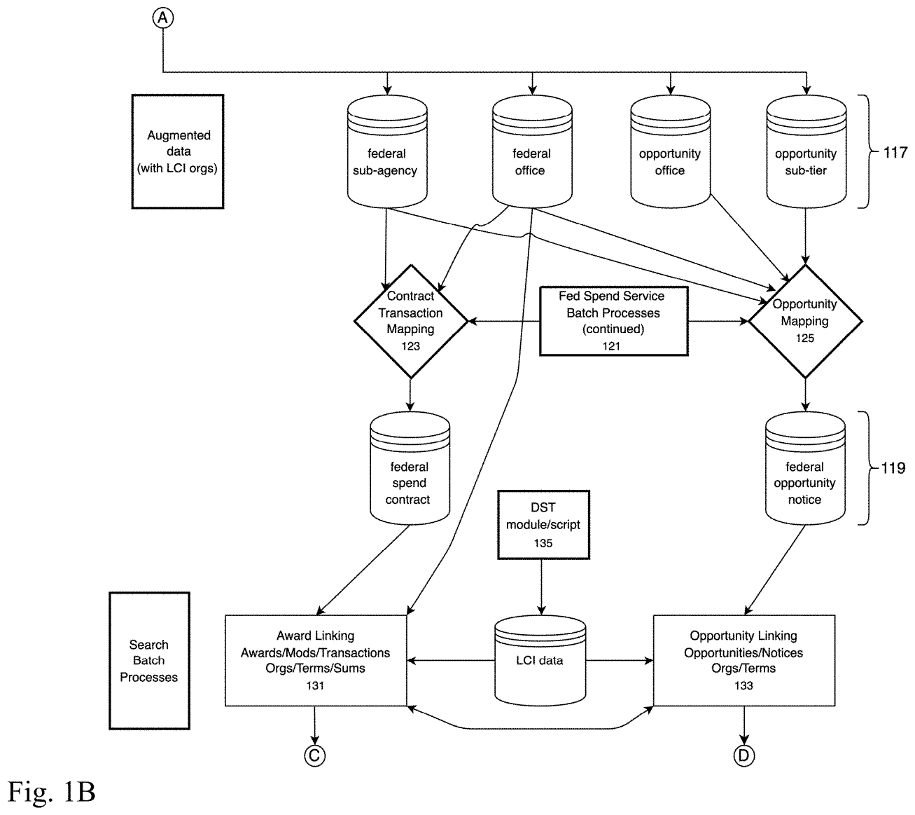

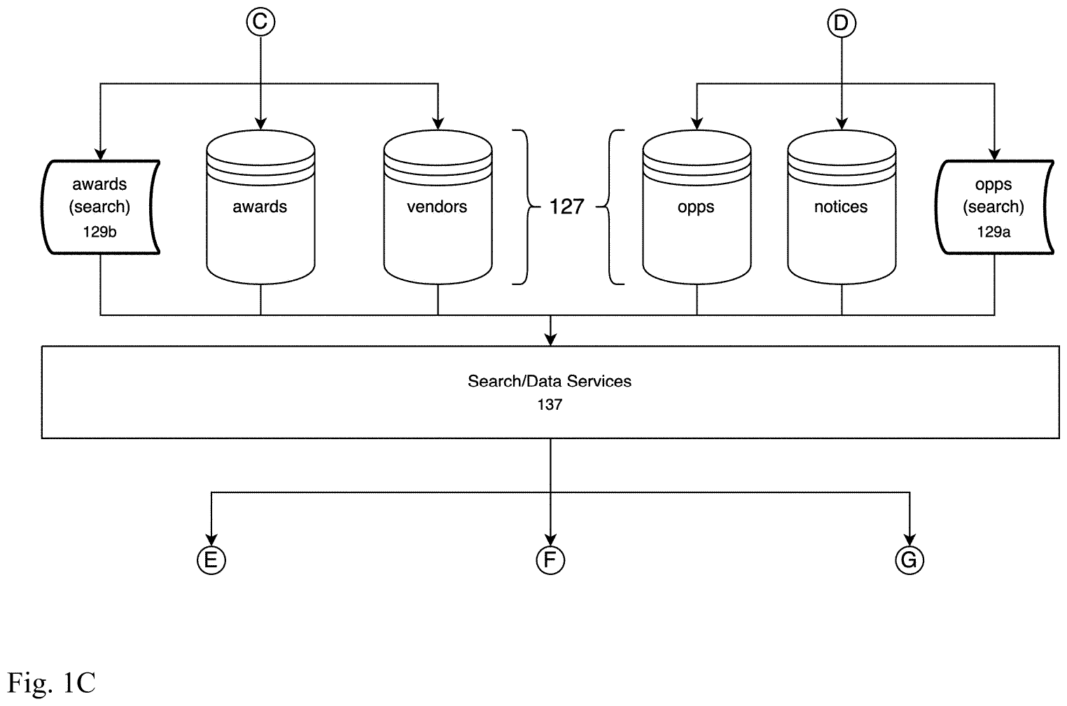

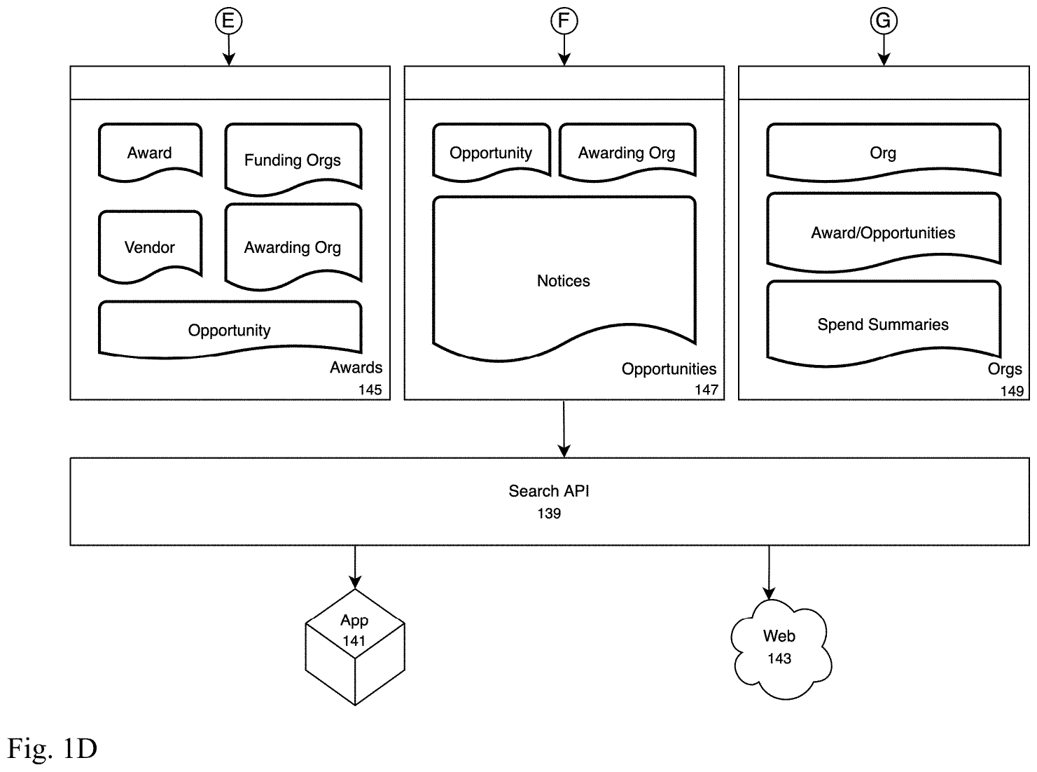

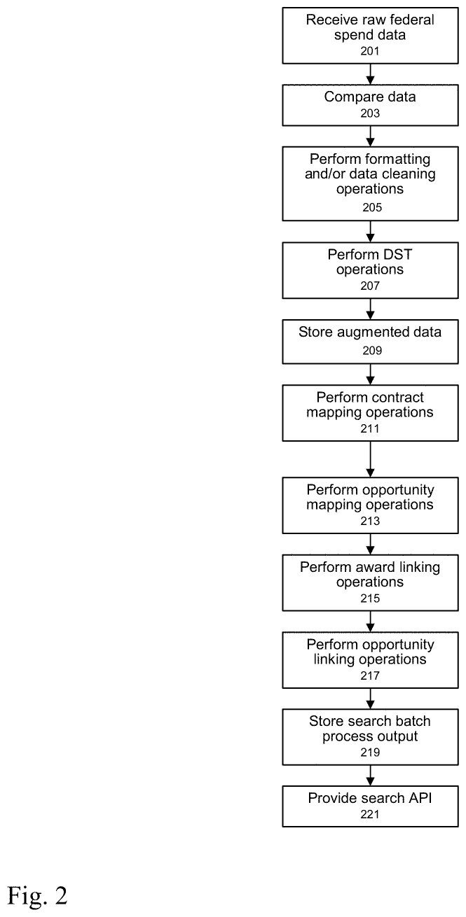

With reference to FIG. 1 and FIG. 2, the data operations performed by the system can include federal spend service batch processes 101. The federal spend service batch processes can involve the system receiving (201) raw federal spend data from various data sources 103. The various data sources can include data sources which regard contract transactions, federal offices (e.g., awarding offices), and opportunity notices. The data sources which regard contract transactions can include usaspending.org and fpds.gov (e.g., accessed via screen scraping and/or via API). The data sources which regard federal offices can include fpds.gov (e.g., accessed via .xls or other spreadsheet file). The data sources which regard opportunity notices can include beta.sam.gov (e.g., accessed via CSS feed, .csv file, and/or via API). The federal spend service batch processes can also include the system comparing (203) data received from the data sources with data already held in raw data databases 105. In particular, the system can compare raw data obtained from the data sources with existing data in the raw data databases 105, and determine new or changed records. Where the incoming data differs from data held in the raw data databases 105, the databases can be updated. Where the incoming data does not differ from data held in the raw data databases 105, the corresponding data of databases can be left unchanged. In some embodiments, the federal spend service batch processes can include the system performing formatting and/or data cleaning operations (205) with respect to the data received from the data sources, and held in the raw data databases 105. As depicted by FIG. 1, in various embodiments databases 105 can include a federal spend contract database, a federal sub-agency database, a federal office database, a federal opportunity notice database, an opportunity office database, and an opportunity sub-tier database.

Further, the system can include search engine functionality 107, by which databases 105 can be searched. The search functionality 107 can be used by the system when performing Data Science Technology (DST) operations (207). In various embodiments, the system can utilize a DST module and/or script 109 in performing the DST operations. The DST operations can include carrying out mapping between various data of databases 105 (e.g., federal sub-agency, federal office, opportunity office, and/or opportunity sub-tier data), and the independently-compiled federal staff organizational data. The mapping can employ various rules, algorithms, and/or machine learning models (MLMs). The mapping can result in augmented versions of various data of databases 105 (e.g., federal sub-agency, federal office, opportunity office, and/or opportunity sub-tier data), and these augmented versions of database 105 data can be stored (209) in databases 117 (e.g., stored as structured data sets). In some embodiments, the DST operations can utilize one or more of fed spend service APIs 111, gateway API 113, and admin portal 115. In various embodiments, when such federal sub-agency, federal office, opportunity office, and/or opportunity sub-tier data databases are mapped/augmented, associated federal spend contracts and/or federal opportunity notices can be updated. The results of such updating can, in various embodiments, be stored in in databases 119 (e.g., stored as structured data sets). Moreover, in various embodiments the DST operations can include linking/tracking through various modifications, across multiple time periods (e.g., over multiple years such as up to over 20 years), of the federal spend contracts. The results of such linking/tracking can, in various embodiments, be stored in in databases 119 (e.g., stored as structured data sets).

The data operations performed by the system can also include continued federal spend service batch processes 121. The continued federal spend service batch processes can involve the system performing contract transaction mapping operations (123, 211) and opportunity mapping operations (125, 213). The contract transaction mapping operations can include mapping both funding and awarding office to respective federal offices. If the federal office to federal staff organizational data mapping is not available, the system can map using a federal subagency to federal staff organizational data mapping. The contract transaction mapping operations can also include adding to the data store (e.g., to the databases 117) federal office information which is received via the various data sources 103, but which is missing from such data store. In some embodiments this can involve attempting to automap a missing office. The automap functionality can utilize one or more MLMs or ML rules to determine a correct mapping for the missing office. As examples, the MLMs or ML rules can analyze a corresponding parent office mapping history, combined with metadata for the missing office.

Further still, the contract transaction mapping operations can include adding to the data store (e.g., to the databases 127) vendor information which is received via the various data sources 103, but which is missing from such data store. The opportunity mapping operations can include mapping opportunity notices to federal staff organizational data. Also, the opportunity mapping operations can include joining opportunity notices to contracts, and normalizing solicitation numbers and award IDs. Further still, the opportunity notice mapping operations can include normalizing text. As just an example, such text normalization can include normalization with respect to line breaks and/or whitelisted html tags. In some embodiments, jsoup and/or another parser can be used in performing such text normalization. Additionally, the opportunity notice mapping operations can include establishing mailto contact links for with respect to the primary contact names of opportunity notices (e.g., via decorated mailto links). The opportunity notice mapping operations can also include adding missing opportunity office and/or opportunity sub-tier information to the data store (e.g., to databases 117). Moreover, the opportunity notice mapping operations can include making notices available via search (e.g., via search 129a). Further still, the continued federal spend service batch processes 121 can include the system handling unmapped office stats generated during periodic (e.g., monthly) processing of one or more of the various data sources 103 (e.g., processing with respect to usaspending.org), and performing indexing with respect to federal offices and/or federal sub-agencies. In various embodiments, one or more results of the continued federal spend service batch processes 121 (e.g., results of the transaction mapping operations and/or opportunity mapping operations) can be stored in databases 119.

The data operations performed by the system can also include search batch process operations. The search batch process operations can include the system linking contract data with opportunity data. Further, the search batch process operations can include the system combining the linked contracts and opportunities with organizational data and people data. In this way search, in a uniform fashion, among contracts, opportunities, organizations, and people can be supported. The search batch process operations can also include performing post processing of the contract, opportunity, organization, and people data, so as to place this data in a final (or near final) form. Further still, the search batch process operations can include exposing such final (or near final) form data to the search engine.

With reference to FIG. 1 and FIG. 2, the search batch process operations can involve the system performing award linking operations (131, 215) and opportunity linking operations (133, 217).

The award linking operations can include processing of awards, modifications, transactions, organizations, terms, and sums. The opportunity linking operations can include processing of opportunities, notices, organizations, and terms. The award linking operations and opportunity linking operations can involve the system utilizing a DST module and/or script 135. In this way, the independently-compiled federal staff organizational data can be utilized by the system when performing the award linking operations and opportunity linking operations.

The output that the system generates in performing the search batch process operations can be stored (219) in the databases 127. As reflected by FIG. 1, the data stored in the databases 127 can include award, vendor, opportunity, and/or opportunity notice data. A given opportunity of the opportunity data can have one or more corresponding opportunity notices among the opportunity notice data. The data placed in the databases 127 can include separate logical datasets, which are generated by the system from the data obtained via the various data sources 103. As such, the separate databases 127 can provide clean datasets, as opposed to, say, a mere tagging of raw data pulled from the various data sources 103. The system can include search engine functionality 129a/129b, by which databases 127 can be searched. The search functionality 129a/129b can be used by the search/data services 137 of the system.

As such, via the operations discussed hereinabove the system has received raw federal spending data from the various data sources 103, and performed the noted processing, such as the augmentation (using the independently-compiled federal staff organizational data), the mapping operations, and the linking operations. Also, the system has stored the resultant data in databases 127. It is noted that the operations discussed hereinabove can allow for relationships between disparate sets of data to be imputed. As an illustration, suppose a set of data “A2” regarding a federal award/opportunity. Further for the illustration, suppose a set of data “B2” regarding the discussed independently-compiled federal staff organizational data (e.g., regarding 50,000 separate office organizations within the federal government, some with 12-18 organizational layers). Then, additionally according to the illustration, a dataset “C2” can be generated from dataset A2 and dataset B2 by applying the operations discussed hereinabove. In particular, this dataset “C2” can, according to the illustration, regard the federal employees that work in the office to which the award/opportunity corresponds, and therefore the people who make the decisions on that award/opportunity. The functionality of search/data services 137 will now be discussed in greater detail.

The search/data services 137 can provide (221) a search API 139. A UI (e.g., app 141 or webpage 143) can interface with the search API 139 to allow a user to search among the data stored in the databases 127. The search/data services 137 can, via the search API 139 and the UI, allow the user to, at the same time, search all four of people, organizations, awards, and opportunities which relate to federal spending. As just some examples, a user can utilize as search input: a) a contract grant/award of which the user is aware, b) names and acronyms of funding and awarding agencies and offices; b) award and opportunity key terms (e.g., “cybersecurity”); c) assigned North American Industry Classification System (NAICS) codes; and d) vendor information, as well as opportunity and award identifiers. As just one illustration, where the user enters “cybersecurity” via the UI, the system can provide the user with cybersecurity-related awards (e.g., including display of corresponding contract(s)) and opportunities (e.g., including display of corresponding solicitations), and also with the people (e.g., federal staff members), organizations (e.g., federal offices, federal sub-agencies, and federal opportunity offices), and/or vendors (e.g., vendors who have placed opportunity bids or who have won contracts) which relate to those awards and opportunities. In this way the user can enjoy benefits including (but not limited to) being informed of federal staff members who can be contacted and influenced in pursuit of the indicated opportunities, as well as indicated vendors who may be competitors for those opportunities.

In some embodiments, the search API 139 can present the databases 127 as having award-related data objects 145, opportunity-related data objects 147, and organization-related data objects 149. The award-related data objects can include objects regarding granted awards, funding organizations (e.g., funding offices), vendors (e.g., who have been granted awards), awarding organizations (e.g., awarding offices), and opportunities (e.g., including an opportunity which led to a given granted award). The opportunity-related data objects can include objects regarding opportunities, awarding organizations, and opportunity notices (e.g., including a posted notice corresponding to a given opportunity). The organization-related data objects can include objects regarding organizations (e.g., federal offices and opportunity offices), awards/opportunities, and spend summaries.

### Example Capabilities

Various capabilities can be provided by the system, utilizing the operations discussed above. A first example capability can apply to opportunities and award contract types, and can include the system allowing a user to search based on an award or solicitation/opportunity known by the user (e.g., with the user searching using a possessed award or solicitation number). Such a user can, for example, have found a contract of interest via Deltek GovWin, Bloomberg Government (BGov), System for Award Management (SAM) of the US federal government, or Federal Procurement Data System (FPDS) of the US Federal Government, and be desirous of learning of the people (e.g., federal staff members and/or competitor employees) involved. Such a user might, for instance, be a senior salesperson, executive, senior business development (BD) person, or policy person. The user—hoping to influence a decision—might, via the search, hope to learn of a starting point/person beyond merely a contract person listed in an opportunity notice.

In connection with this first example capability, the UI provided by search/data services 137 can allow the user to enter a corresponding award or solicitation number into a provided search UI element (e.g., bar). In reply to the entry by the user, the system can display to the user information including indication of the involved people. In various embodiments, the system can also return basic contract information, thus allowing the user to be confident that the expected result has been returned by the system. As just one example, the UI can show a corresponding contract first and then display the involved people in response to the user performing a click. As just another example, the UI can display the corresponding contract with indication of the involved people superimposed thereupon, without call for the user to perform a click. In some embodiments, the user can refine by people/orgs using filters and/or can click down to a person or organization (e.g., federal office, federal sub-agency, or federal opportunity office). As such, the first example functionality can provide a simple and clean UI which offers few or no filters, and therefore can allow non-technical users to enjoy a non-cumbersome experience.

A second example capability can also apply to opportunity and award contract types, and can include the system allowing a user to search based on an organization (e.g., federal sub-agency or opportunity office) or person known by the user. Such a user can, for example, know the people and organizations believed to be relevant, and want to know one or more of: a) the awards/opportunities that those people and organizations influence; b) the awards/opportunities influenced by parent, peer, and sub-organizations of those people and organizations; c) whether those people and organizations are the correct people/organizations influence-wise, or whether more senior people and/or higher-level organizations should be dealt with instead. Such a user might, for instance, be a senior salesperson, executive, senior BD person, or policy person. The user might, via the search, hope to: a) confirm whether their existing contacts are solid/correct; b) determine the individual in charge up one level in the relevant organization from a known person; c) determine whether an office known by the user is in charge of a decision cared about by the user; and/or d) determine senior people in an organization known by the user.

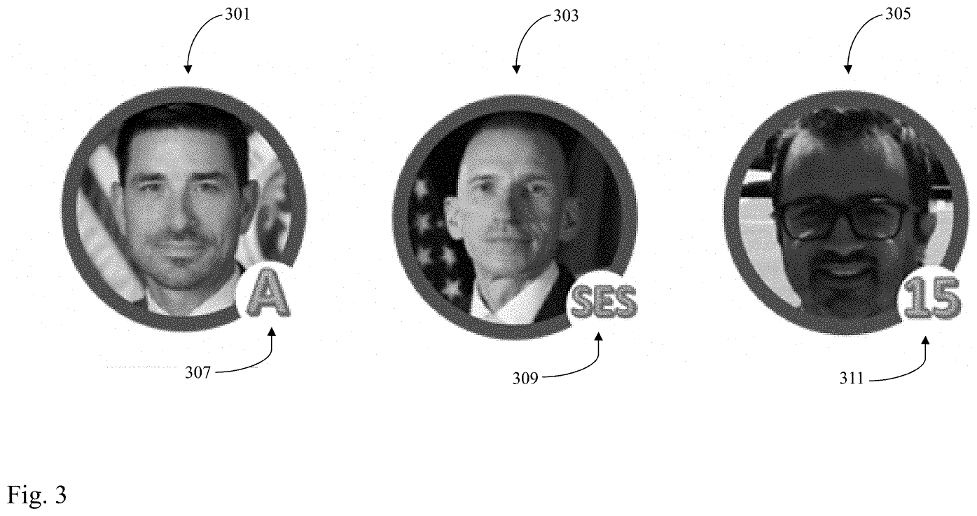

In connection with the second example capability, the UI provided by search/data services 137 can allow the user to enter an organization or person known by the user. In reply to the entry by the user, the system can display to the user one or more of: a) contacts (e.g., senior contacts); b) contracts at the organization and/or person level; and/or c) browsable contracts (e.g., organized by award type, subject area, NAICS code, and or description). In some embodiments, such display of contacts can include highlighting senior contacts visually. For instance, with reference to FIG. 3 the UI can show images of such senior contacts 301, 303, and 305 with indicators superimposed thereupon (e.g., “A” 307 indicating appointee, “SES” 309 indicating Senior Executive Service, and “15” 311 indicating GS-15). As such, the second example functionality can provide a simple and clean UI which offers few or no filters, extends self-discoverability, and saves the user from having to execute a multitude of clicks.

A third example capability can also apply to opportunity and award contract types, and can include the system allowing a user to search based on a code (e.g., NAICS code), competitor, or keyword. Such a user can, for example, want to know of white spaces where their product is not yet marketed, but should be. Such a user might, for instance, be a senior salesperson, executive, senior BD person, or policy person. Such a user—perhaps having a small sales team—can, for instance, find it hard to determine those federal offices that can buy or benefit from his/her product. The system can aid this user by, for instance, determining those offices that have made past decisions relevant to the focal area of the user's business. Where, as an example, the user has indicated a competitor, the system can return information which can aid the user in competing for renewal contracts corresponding to that competitor.

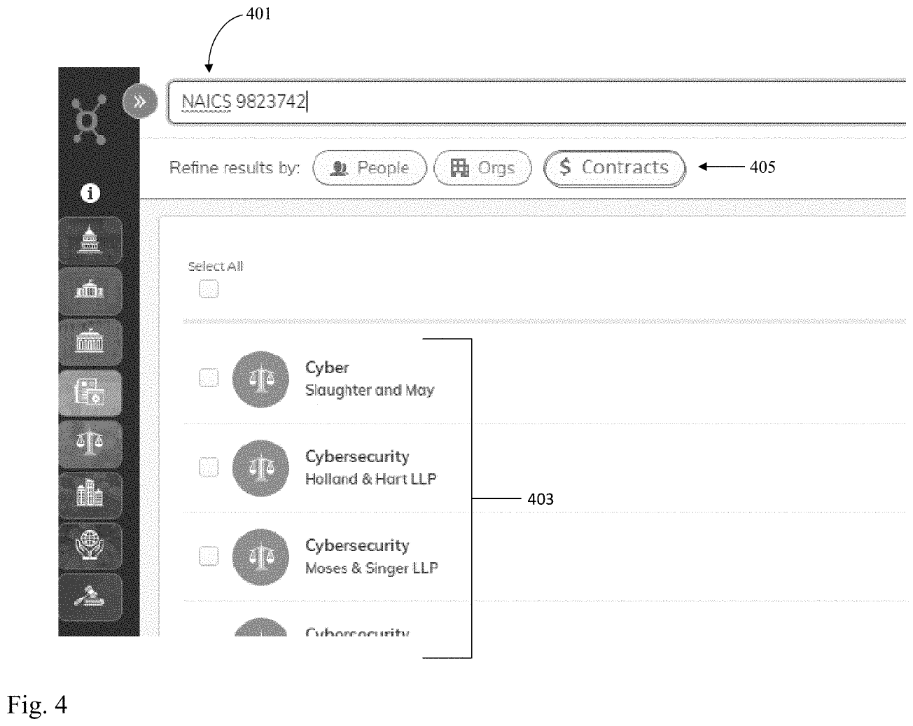

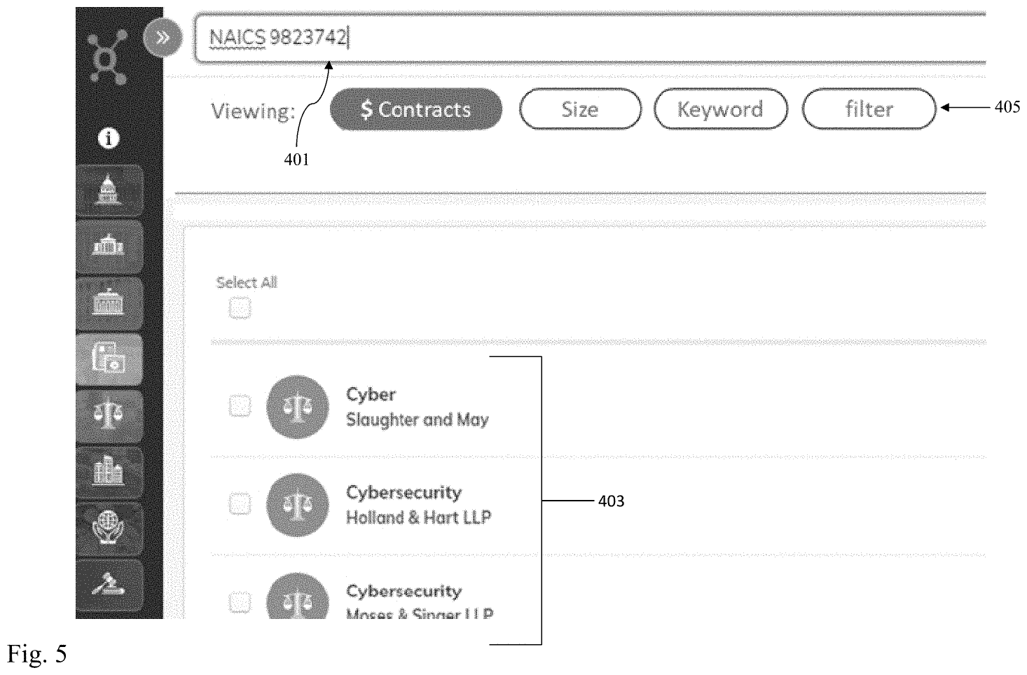

In connection with the third example capability and with reference to FIG. 4 and FIG. 5, the UI provided by search/data services 137 can allow the user to enter a code (e.g., NAICS code), keyword, or competitor 401. In reply to the entry by the user, the system can display to the user contracts, organizations, and people 403. The UI can allow the user to select one of these three items in order to drill down for receipt of further information. Further, the system and allow the user to: a) click on an entry; b) use UI pillboxes 405 (or other UI elements) to filter by organization, person, contract or other entity; c) where the user filters by, for instance, contract, allow the user to filter by size, agency, and/or award type; and/or d) drill down on

NAICS code (or other code) to corresponding description. As such, the third example functionality can offer an easy click-and-explore experience for inexperienced users, allowing the user to receive results without having to perform a multitude or sorting or clicking.

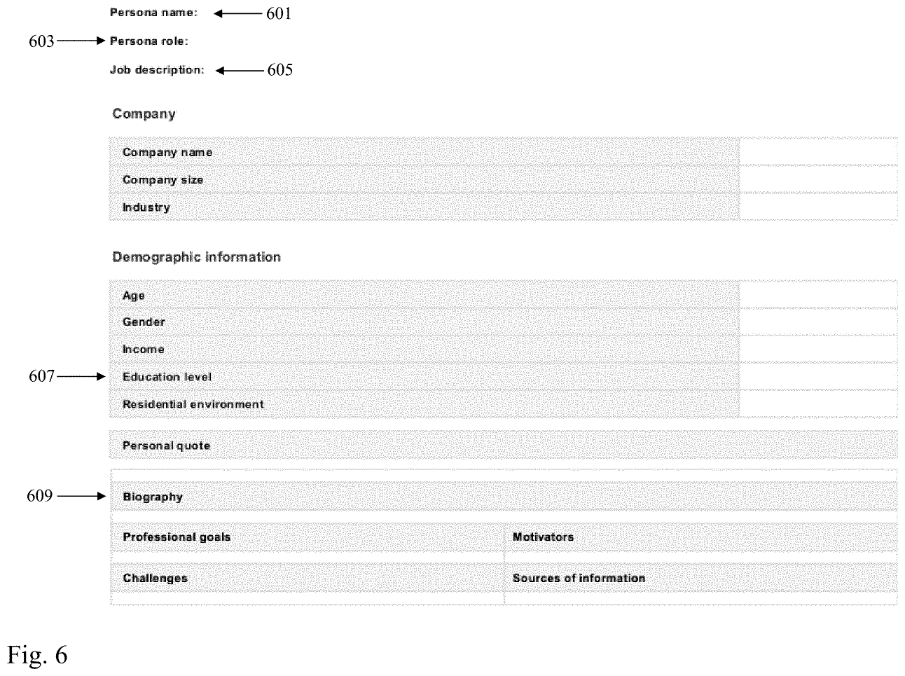

Turning to FIG. 6, shown is an example UI applicable to capabilities of the system including the just-discussed first-third capabilities. As depicted by FIG. 6, the system can use the UI to provide to the user various information about a person (e.g., federal worker or contractor employee) such as name 601, role 603, job description 605, educational level 607, and biography 609.

More generally regarding example capabilities, utilizing the operations discussed above the system can provide the user with insight into the people who make decisions and/or influence federal spend; insight greater than mere [Value]) by [Subject], [Office], [Solicitation Number], [Award Number] and [NAICS Code] information. As just one example, by informing the user of whom (e.g., which federal employee(s)) to engage with when requirements are still being determined (e.g., long before a corresponding Request for Proposal (RFP) or Request for Information (RFI) is written), the system can empower the user to ensure that their unique product specifications form the foundations of any RFI/RFP published. In this and other ways, the system improves the ability of the user to sell into federal agencies. Because of the complexity of federal agencies (e.g., large quantity of employees, large quantity of offices, very hierarchical personnel structure) it difficult for users, using conventional approaches, to determine starting points for beginning their selling processes. For example, conventional approaches typically only focus on open or awarded contracts, and offer merely rudimentary search tools to users. In contrast, the at-hand system provides benefits including but not limited to providing functionality to users which is on one hand sophisticated, but on the other hand can be accessed via an elegant, intuitive, and non-technical UI. In an aspect, the at-hand system can meet the needs of demand generation-concerned users, and not just contract/RFP/price-driven users. The user of the system can be, for example, an employee of a company that sells something that solves a problem for federal agency clients. The system can aid the user by identifying decision makers (e.g., federal employees) who can have that particular problem. The system, as referenced, providing early identification to the user as to whom to engage is highly useful; by the time an RFP comes out it is usually too late to win the business, for instance a competitor can have already shaped the corresponding RFP to fit product specifications of the competing product.

The system can, in just one aspect, determine the identities of the particular individuals (e.g., federal employees) who can generate an RFP that is formulated in a way beneficial to the user (e.g., to a company of the user). As an example, this can involve the system determining the identities of the decision makers in an agency that owns a solved by the user's company. Also, as an illustration, the user can be associated with a company that sells tech-based products. But, the user's prospects can be non-technical people having problems that require technical solutions (e.g., a finance head can be worried about cost overruns in a new missile program (non-technical problem), and the solution can be implementing project management software (technical solution)). Further, a federal decision maker can be several steps removed from the operator. Under these and other circumstances, the system can provide significant value to the user by helping them navigate varied personal connections.

The system can utilize various approaches in ascertaining such decision makers, and other relevant individuals (e.g., federal employees). As just some examples, the approaches utilized by the system can take into account one or more of people who: 1) have made similar purchase decisions in the past; 2) belong to offices within federal agencies that are known to influence types of decisions akin to the at-hand decision; and 3) are responsible for the subject area that is the focal point the at-hand product or service. In implementing this functionality, the system can provide to the user a UI that allows the user to identify a particular product/service type (e.g., cybersecurity software) to the system. Subsequently, the system can allow the user search, with respect to this product/service type, by one or more of: a) subject; b) office; c) solicitation Number; d) award number; e) NAICS code (or other code); f) person; g) position; and h) keyword.

Also regarding example capabilities, utilizing the operations discussed above the system can support the needs of the user with respect to demand generation and displacement/add-ons. The sphere of demand generation can regard start-from-scratch sales. Here, the user can have identified a prospect with the particular problem that a product, offered by the vendor for whom the user works, solves. The user can hope to identify a senior person in the office whom they need to influence (e.g., a finance head, experiencing cost overruns in a government program, who can benefit from project management software sold by a software-as-a-service (SaaS) vendor for whom the user works). The user—perhaps bearing in mind a demand generation process of engage->educate->excite->nurture->convert—can use the system to determine with whom to engage.

The sphere of displacement/add-ons can regard the user looking to pick up renewal business/re-competes, or to get work on top of an existing award. The sphere of displacement/add-ons can include scenarios where a federal agency is displeased with the performance of a current product/service (or agency needs have changed), and the agency is: a) looking for a full replacement; or b) has expanded the scope of the relevant project, and is in need of additional services. To support the displacement/add-ons sphere, the system can act, in a manner analogous to that discussed above in connection with demand generation, to look for decision makers that meet relevant criteria), but with the additional functionality of identifying deals that are coming up for renewal, or are in need of repair. In some embodiments, such deal identification can include the system intaking and analyzing various federal documents, such as General Accounting Office (GAO) or other reports that evaluate federal spend. By analyzing these reports utilizing the operations discussed above, the system can map contracts to problems to people. As an illustration, the system might intake and analyze a GAO report regarding Navy ship drives, and indicating that the Navy does not know if the new ship drives will prevent collisions. Here, where the system is operating on behalf of a user who works for a vendor that sells a product/service that can aid the Navy, the system can analyze the report and notify the user (e.g., via a UI) of the potential opportunity.

The system can be capable of aiding a wide variety of users. For example, the system can be accessible to, as just one example, users who are senior and client facing, but busy and nontechnical, having teams of analysts at their disposal. In being accessible to such users, the system can provide a UI which is self-navigable, with the only “training” being awareness (e.g., it being the case that once the user has been informed (e.g., via a system UI) of a capability of the system, use of the capability can be obvious). As just some examples, the system can: a) put nuggets of federal spend content into profiles displayed via the system UI; b) make it easy to locate various system resources/capabilities via a search bar (or other UI element) of the system; and/or c) place push messages briefings (or other system-generated content) that inform the user of various system resources/capabilities. More generally, the system can be capable of aiding both strategic category users and tactical category users. The strategic category users can include users who no longer expect to do any market analysis themselves, but instead are responsible for deciding upon the direction that their business is to take, and managing the senior, key relationships within clients. The tactical category users can include users whose role is to provide in-depth analysis of market opportunities.

In one aspect, the functionality discussed hereinthroughout can be used by companies/vendors hoping to be awarded federal contracts. In another aspect, the functionality discussed hereinthroughout can be used by federal workers (e.g., decision makers). In this regard, as discussed above, the system can store and process, for instance, data relating to companies/vendors and awards. More generally, the system can store and process various information regarding companies/vendors, such as those that have applied for and/or been awarded contracts in the past. Utilizing this information, the system can allow federal workers to learn about companies/vendors. The system can provide such functionality utilizing approaches analogous to those discussed herein in connection with use of the system by companies/vendors. Using such functionality, various benefits can be enjoyed by the federal workers, such as receiving from the system enough information about relevant companies/vendors so as to obviate call for an RFI.

Additional example capabilities which can be provided by the system, utilizing the operations discussed above, include answering the following user questions/directives (e.g., submitted via a UI of the system): a) who is responsible for purchase decisions of a specified product/service or field (e.g., cybersecurity software purchase decisions)?; b) who is responsible for purchase decisions relating to a specified NAICS (or other) code?; c); who is responsible for purchase decisions relating to a specified award number?; d) who is responsible for purchase decisions relating to a specified solicitation number?; e) to whom does a specified contact report?; f) who are the peers and subordinates of a specified contact?; g) what is the organizational hierarchy at the office that influences a specified potential purchase (e.g., of a product/service that the user is selling)?; h); what services has a specified office historically purchased?; i) from which vendors has a specified office historically made its purchases? j) who is the incumbent vendor/company for a specified product/service or field?; and k) what competitors might be expected to bid on specified opportunities (and/or opportunities being tracked by the user). In answering these questions, the system can utilize the operations discussed above, along with the performance of one or more of: a) searches using user-specified or system-generated keywords which yield spend results; b) organization searches on user-specified or system-generated keyword(s) and then browsing contracts; c) and profile searches on user-specified or system-generated keyword(s) and then browsing contracts.

Still further example capabilities which can be provided by the system utilizing the operations discussed above include answering the following additional user questions/directives (e.g., submitted via a UI of the system): a) which agencies/offices will have the problem my product/service (e.g., software) will solve?; b) I know we are better than a specified vendor (e.g., classic displacement); c) I can ride the coattails of awards that look like the specified ones; d) protect my existing business by extending existing relationships within agencies I do business with; and e) help me land and expand. As to “a),” the system can, as just one example, perform searching according to one or more of user-specified or system-generated: 1) NAICS code(s) (or other code(s)); 2) position(s); 3) keyword(s); 4) GAO report(s) (or other government-issued reports); and 5) awarded vendor(s) (e.g., competitors). As to “b),” the system can search for and analyze existing deals to find ones where the vendor/company with whom the user is associated can improve the outcome (e.g., cost/performance), and/or analyze deals awarded to the vendor specified by the user to determine whether an improved outcome can be achieved over that vendor. As to “c),” the system can search for existing deals that the vendor/company with whom the user is associated is a complement to (e.g., a data vendor looking for Salesforce deals). Here, the system can also take into account a user-specified company/vendor (e.g., a company/vendor which the user suspects to be relevant). As to “d),” the system can, as just one example, perform proactive personalization, wherein the system automatically sends people changes for the groups where the user has existing awards (or other business), without call for the user to explicitly request that the system do so. As to “e),” the system can, as just one example, perform proactive personalization, wherein the system automatically sends people suggestions for the groups where the user has existing awards (or other business), without call for the user to explicitly request that the system do so. Further, the system can look for the positions the user does business within an agency, and then suggest people with the same position type in the same agency. In this way, the system can support functionality which allows a user to secure a small deal within an agency, and then aim to find other areas within the same agency to sell to (e.g., where the user works with a Chief Information Security (CISO) for the Transportation Security Administration (TSA), the system can aid the user by suggesting that they contact a CISO for the DHS).

### Dashboard

According to various embodiments, the system can, utilizing the operations discussed above, provide a dashboard UI. The dashboard can allow the user to easily: a) discover; b) browse; and c) search federal spend data in ways previously not possible. The dashboard functionality can provide benefits including but not limited to generating business opportunities for the user, and saving them time by allowing them to easily get to federal spend opportunities that can grow their businesses. In some embodiments, the dashboards can be implemented as an integral part of an office (e.g., opportunity office) profile page, and/or can be a central UI landing spot aggregating and displaying much or all federal spend data to users.

The system can provide predictive functionality via the “discover” functionality of the dashboard. The discover functionality of the dashboard can present the user with information that they were not necessarily looking for in the first place. As just an example, such information can be an award or opportunity that they never knew existed, or an office that they never knew was a potentially important place to do business. As another example, such information can be an insight that provides interesting cuts, and/or an aggregation of data that shines new light how federal dollars are being spent. In this way, the discover functionality can show the user starting points, such that they do not need to know what they are looking for.

The “browse” functionality of the dashboard can display information to the user that provides the user with starting points to browse through lists of spends/awards, and/or opportunities. The browse functionality can display organized starting points to the user such as spend by office, NAICS code, and date. In this way, the browse functionality can take the guesswork out of search. From the starting point provided by the system, the user can execute clicking to receive further information from the system. The “search” functionality can provide a simplified search which includes various filters (e.g., basic filters), and can expect the user to have a sense of that which constitutes valuable information, and possess a certain degree of searching skill.

As such, the dashboard functionality can provide a user friendly (e.g., BD user friendly) approach, in contrast to data wonk-oriented services such as BGov and GovWin. Further, BGov, GovWin, and similar services tend to require that users both have a specific idea of the data that they hope to discover, and the technical acumen to find such data. As such, BGov, GovWin, and similar service tend to, at best, be feasible only for a small segment of research-focused users, and not for other users, such as BD users. Moreover. BGov, GovWin, and similar services can provide flawed data to their users. As one example, such services have a tendency to utilize incorrect metadata in their processing, leading to errors such as relating an award to an incorrect office. As another example, such services have a tendency to propagate onward data entry errors which exist in intaken data. In contrast, as just two examples, via the approaches discussed herein awards are correctly mapped to offices, and data entry errors are corrected (e.g., via the system recognizing inconsistencies between the erroneous data and corresponding data held by the system).

According to various embodiments, there can be two dashboards: an organization level dashboard and a global dashboard. The organization level dashboard can present a summary of information at the organization (e.g., federal office, federal sub-agency, or federal opportunity office) level. The global dashboard can aggregate some or all federal spend data. By providing the two dashboard types to users, the system can present the users with browsable data in the two areas where users tend to start their searches, thereby allowing for benefits, such as prompting users who do not know exactly what they are looking for, to accrue.

The global dashboard UI can display one or more of discover cards, opportunity blocks, federal spend graphic blocks, award blocks, federal opportunity graphic blocks, and office award distribution information. The discover cards can display data insights and aggregations. The system can display either or both of static discover cards and interactive discover cards.

The static discover cards can be implemented as flat images (e.g., jpeg images) with stats and charts. In various embodiments, the static discover cards can be without hyperlinks. The interactive discover cards can provide the functionality of the static discover cards, but further include hyperlinks. For instance, card images can include hyperlinks which lead to profile pages, awards, opportunities, lists of awards and/or opportunities, or other destinations.

Further, the discover cards can serve to display graphical roll-ups that are useful for and/or pleasing to users (e.g., BD users). More generally, the discover cards can provide never-before-seen and/or highly complex insights on federal spend. As just some examples, the information presented by a discover card can include: a) total spend for United States Department of Defense for FY 2019; b) total spend for NAICS code 541512 (computer systems design services) for FY 2019; c) total spend for NAICS code 541618 (other management consulting services) for FY 2019; or d) total value of all opportunities to date FY 2020.

The opportunity blocks can provide users with the ability to sort and/or filter opportunity results, and can serve as browse components (e.g., as main browse components) of the dashboard. Key elements for opportunity blocks can include keyword, NAICS, date (e.g., last 10, last month, last 3 months, last 12 months, etc.), and top agencies (e.g., DoD, DHS, Veterans Affairs (VA), Department of Commerce, State Department). In some embodiments, the key display for opportunity blocks can be the last 10 opportunities. As such, opportunity blocks can display opportunity data in a way easily usable by BD users, and other users. The federal spend graphic blocks can display aggregated government spend, and can offer the user the ability to, as just one example, initially drill down by a first aspect (e.g., agency), then by a second aspect (e.g., NAICS), and then by a third aspect (e.g., date). Further, clicking on a graphic provided by a federal spend graphic block can send the user to a search result. Award blocks can provide functionality analogous to opportunity blocks, but with respect to award data rather than opportunity data. Federal opportunity graphic blocks can provide functionality analogous to federal spend graphic blocks, but with respect to federal opportunity data rather than federal spend data, and in some embodiments using quantity of deals instead of dollar amount. In this way, federal opportunity graphic blocks can display data in a way easily usable by BD users, and other users. Finally, the office award distribution information can display some or all offices in the federal government, ranked by most spend to least spend (or vice versa). The chart can, as just some examples, be filtered by agency, code (e.g., NAICS code), date range, and/or keyword.

In various embodiments, implementation of the dashboard can target one or more user personas. As just some examples, the user personas can include BD user, capture team lead, and data miner. The BD user persona can represent a user who is a high level salesperson or relationship person. Such a user can have a senior role, but be non-technical. The capture team lead persona can represent a user who possesses a senior/ fairly senior role, and who looks at federal spend against their organization's capabilities and decides on bid/no-bid. A bid process can take 1-2 years, and can involve pre-building capabilities within in their organization. Then, the data miner persona can represent a user who possesses a junior role, and who can be a junior BD or marketing employee. They can act to mine federal spend data, and uncover information that the BD team can use to initiate or extend client relationships.

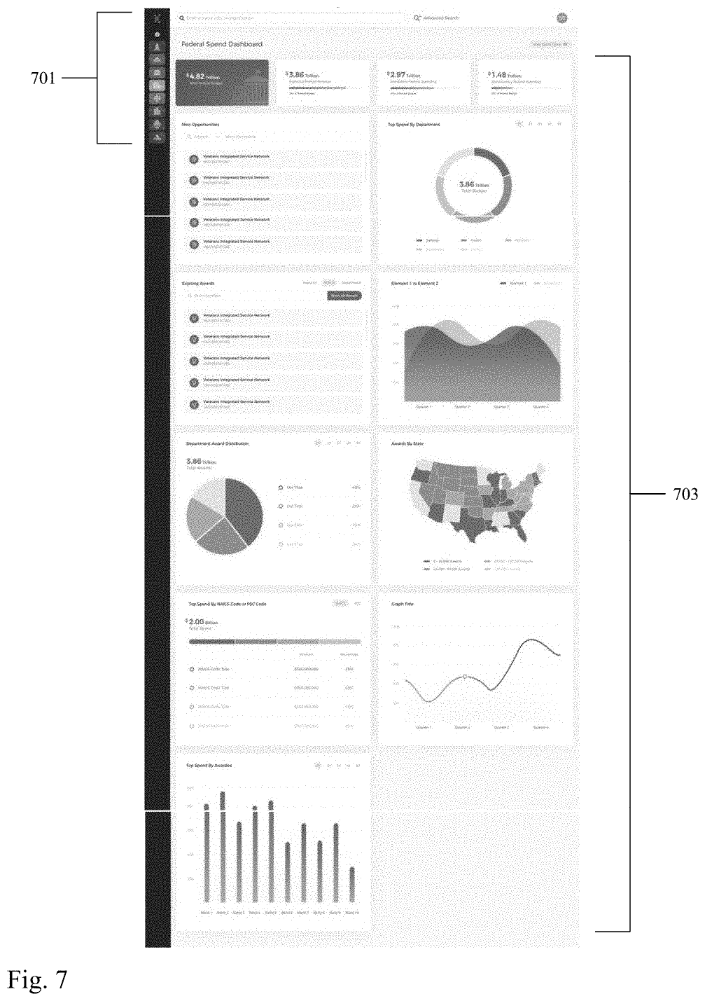

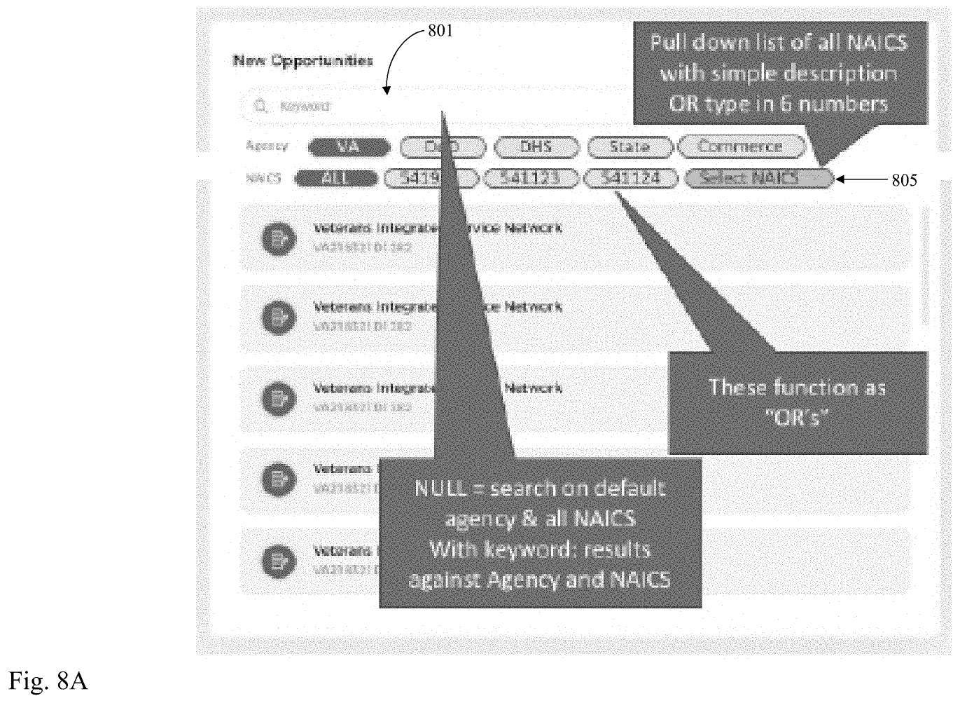

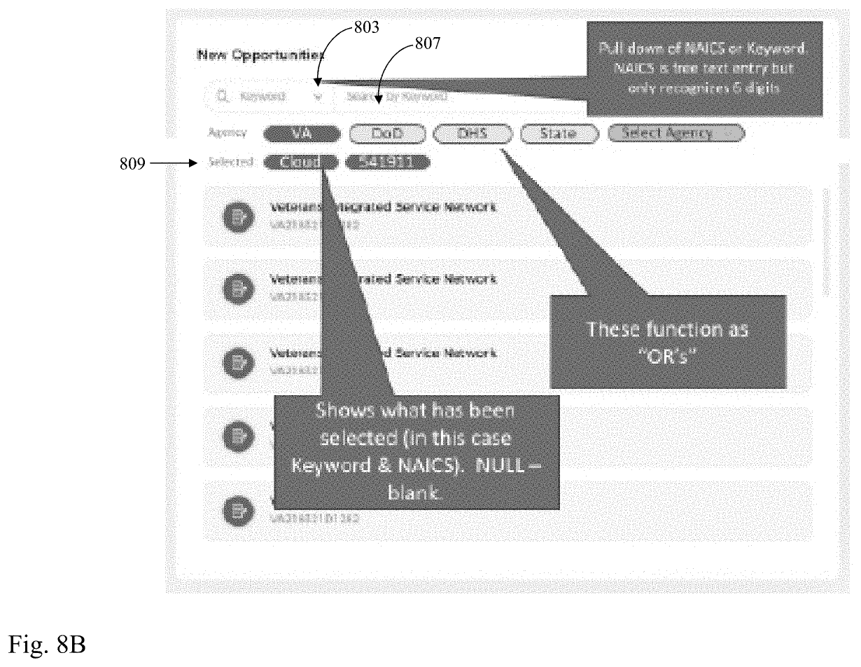

Shown in FIG. 7 is an example dashboard UI. The dashboard (e.g., via a UI header 701 thereof) can present multiple cards (e.g., of the sort discussed), which can display interesting facts about fedspend data. Such facts can be as determined by the system from the various data sources 103, utilizing the operations discussed above. As such facts are likely to change over time, the system can act to update the cards with regularity. According to various embodiments, two searches can be created as cards for the dashboard: new opportunities and expiring awards. With reference to FIGS. 8A and 8B, a new opportunity search card can as one example utilize exposed search terms (see FIG. 8A and UI text field 801), and as another example utilize hidden search terms (see FIG. 8B and UI pull down 803).

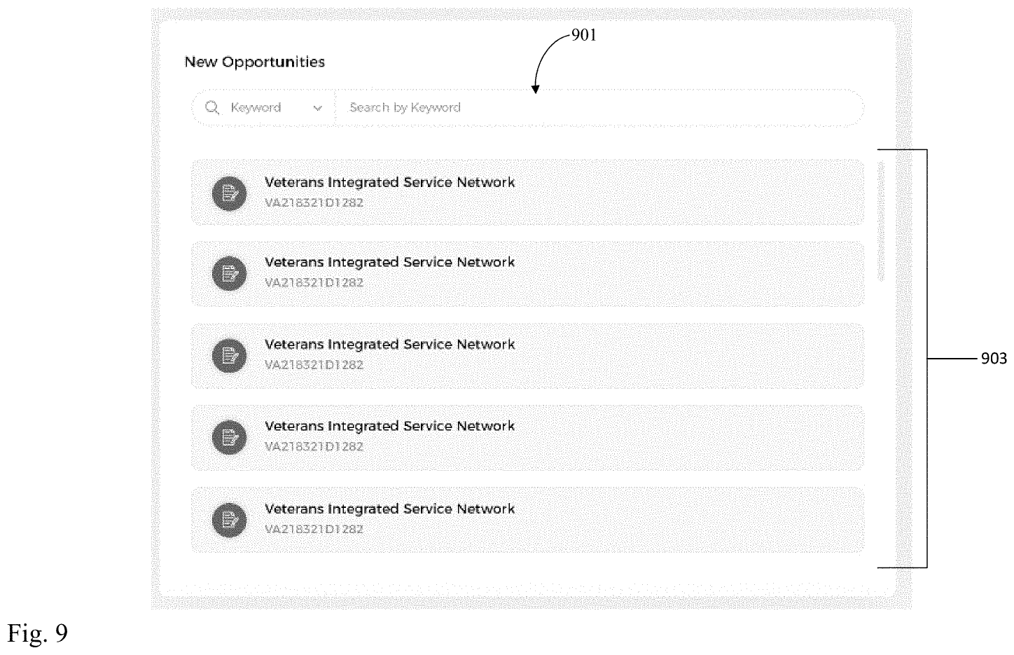

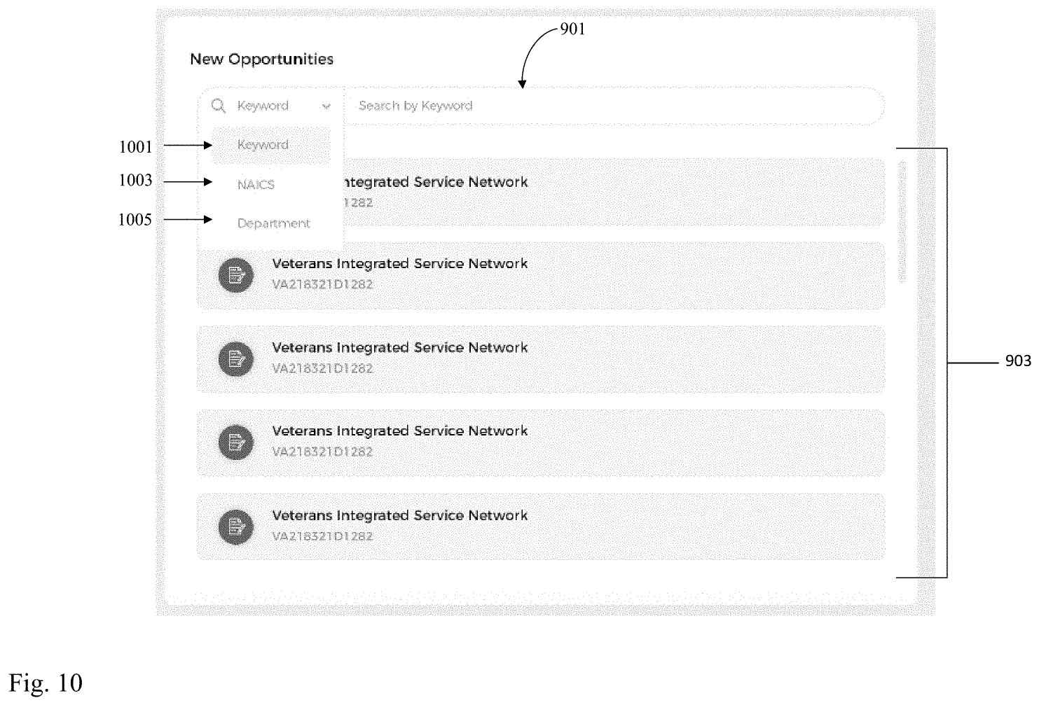

As referenced by the corresponding callout of FIG. 8A, where the user uses UI text field 801 to enter a keyword, the system can return corresponding results (e.g., against agency or NAICS code). As also referenced by this callout, where the user enters no text in UI text field 801 the system can return results which correspond to one or more default agencies and/or to certain (e.g., all) NAICS codes. Then, as referenced by the corresponding callout of FIG. 8A, where the user selects a UI pillbox 805, the system can allow the user to utilize a UI pull down which lists certain NAICS codes (e.g., all NAICS codes) along with corresponding descriptions. Alternately or additionally, the system can allow the user to type in the six digits of an NAICS code. As referenced by the corresponding callout of FIG. 8B, UI pull down 803 can allow the user to select from among presented NAICS codes and keywords. As also referenced by this callout of FIG. 8B, the user can use UI text field 807 to perform free text entry, such as of NAICS codes. Further, as referenced by the corresponding callouts of FIGS. 8A and 8B, applied constraints (e.g., agency or NAICS constraints) can be applied in an OR-wise fashion by the system when yielding search results. Further still, as referenced by the corresponding callout of FIG. 8B the UI can indicate (809) the particular constraints that the user has selected (e.g., a keyword and an NAICS code). With reference to FIG. 9 and FIG. 10, search cards can support nested search (e.g., via UI text field 901). Such nested search can, for example allow for filtering by the opportunities domain, and can allow for retrieval/display of data for a given number of time units (e.g., previous six months) for a date specified by the user. As just one example, by default the five most recent opportunities from the data sources can be displayed (903), with the user being able to use the UI to request display of the remainder. In some embodiments, a maximum quantity of displayed opportunities can be set (e.g., 50 opportunities). Further, a new opportunity search card can allow for search by multiple (e.g., three) selectable areas. As an example, the multiple selectable areas can be: a) keyword 1001, allowing the user to search using keyword to display a list of opportunities; b) code 1003 (e.g., NAICS code), allowing the user to enter an NAICS code (or other code) to display a list of opportunities; and c) department/agency 1005, allowing the user to enter a department/agency name to filter to only opportunities matching the selected department/agency.

With further regard to new opportunity search cards, according to a first implementation the card can expose the search terms and popular alternatives for, as just two examples, NAICS and agencies. Such functionality can facilitate use by BD users, or other less technical users. According to a second implementation, does not perform such exposing to the user. Such functionality can provide a more elegant search experience for more technical users. In some embodiments, these two implementations can be based on the surfacing of or hiding of filters.

When displaying opportunities to the user, the new opportunity search card can display a given quantity (e.g., five) of the most recent opportunities (e.g., based on applied filtering and/or entered search terms). Also when displaying opportunities to the user, the new opportunity search card can allow the user to select a displayed opportunity. In response, the system can provide the user with additional information about the opportunity. Moreover, the new opportunity search card can allow the user to select the desire to view all opportunities. In response the system can be transported from the dashboard to a regular search result page. Once there, the use can scroll through the displayed opportunity list, or add filters. In some embodiments, the new opportunity search card can implement a keyword text entry field and a list of opportunities as selectable areas.

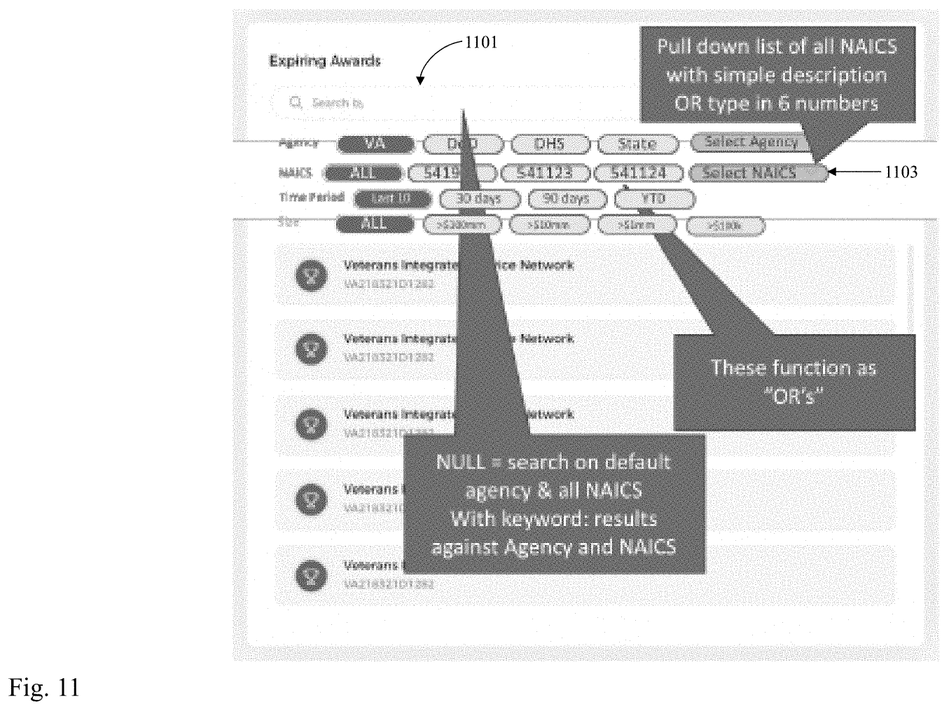

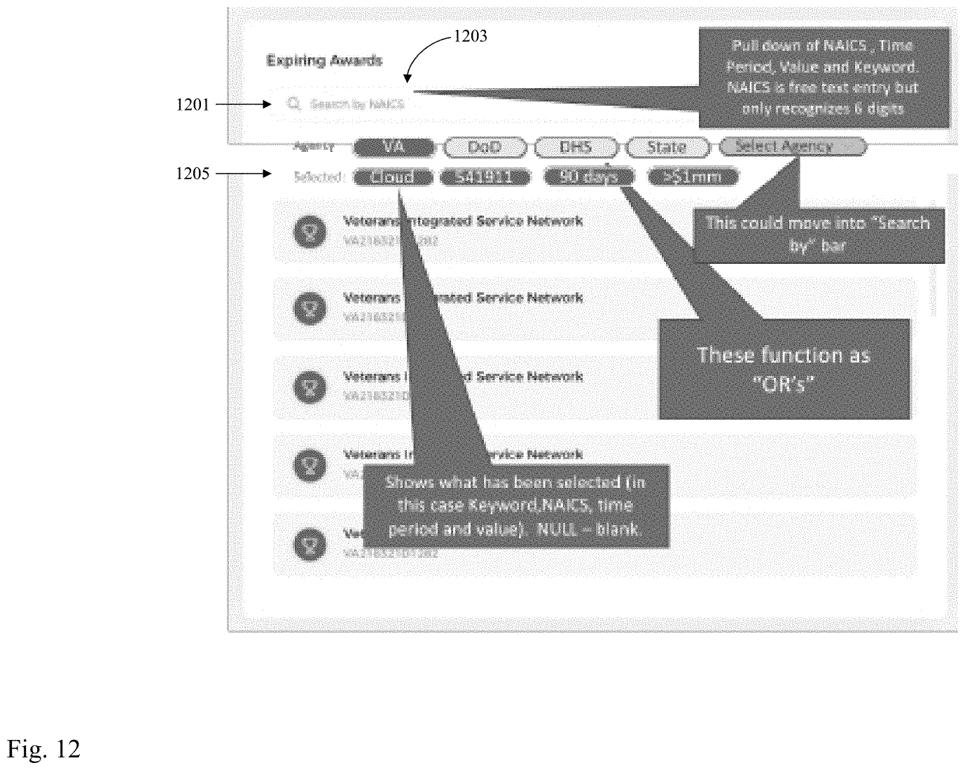

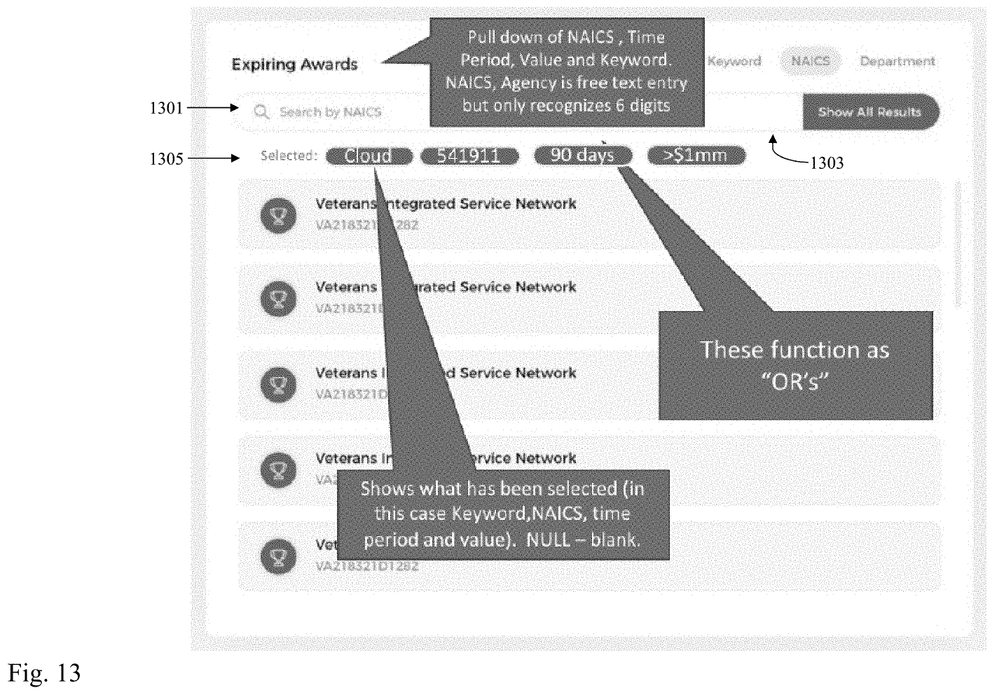

With reference to FIGS. 11-13, an expiring award search card can: a) expose search terms, as per FIG. 11; b) semi-expose search terms, as per FIG. 12; and c) hide search terms, as per FIG. 13. As referenced by the corresponding callout of FIG. 11, where the user uses UI text field 1101 to enter a keyword, the system can return corresponding results (e.g., against agency or NAICS code). As also referenced by this callout, where the user enters no text in UI text field 1101 the system can return results which correspond to one or more default agencies and/or to certain (e.g., all) NAICS codes. Then, as referenced by the corresponding callout of FIG. 11, where the user selects a UI pillbox 1103, the system can allow the user to utilize a UI pull down which lists certain NAICS codes (e.g., all NAICS codes) along with corresponding descriptions. Alternately or additionally, the system can allow the user to type in the six digits of an NAICS code.

Considering FIGS. 12 and 13, as referenced by the corresponding callouts, UI pull downs 1201 and 1301 can each allow the user to select from among presented NAICS codes, time periods, values, and keywords. As also referenced by these callouts, the user can use UI text fields 1203 and 1303 to perform free text entry, such as of NAICS codes and agencies. Further still, as referenced by the corresponding callouts of FIGS. 12 and 13 the UI can indicate (1205, 1305) the particular constraints that the user has selected (e.g., a keyword, an NAICS code, a time period, and a value). Also, as referenced by the corresponding callouts of FIGS. 11-13, applied constraints (e.g., agency or NAICS constraints) can be applied in an OR-wise fashion by the system when yielding search results.

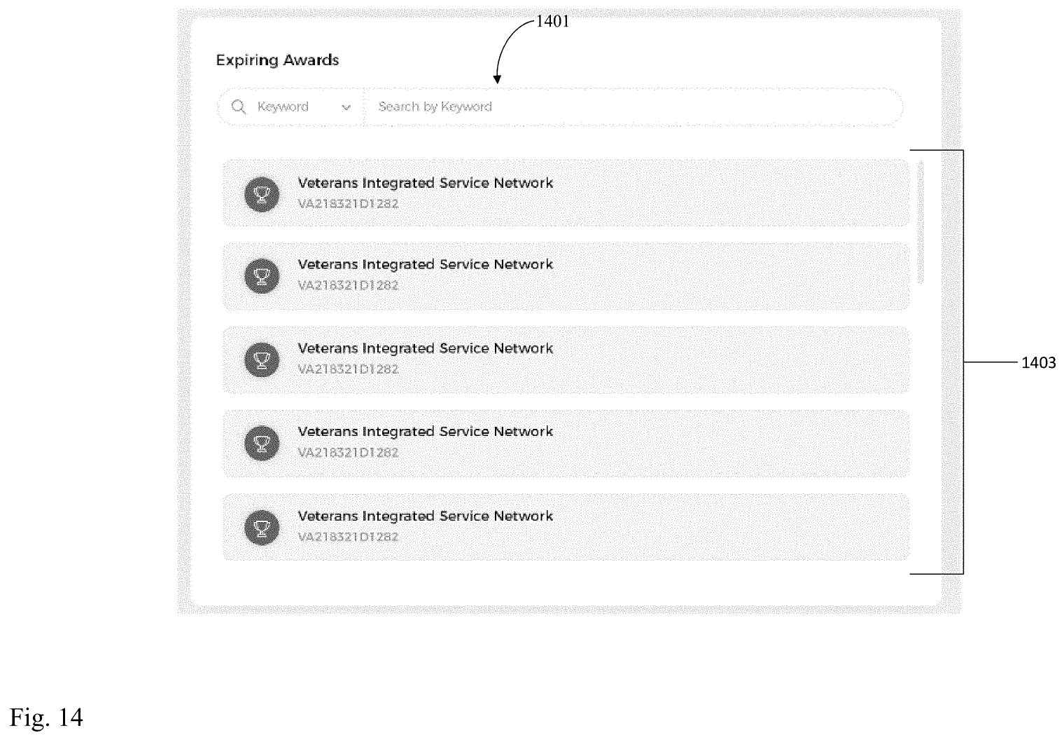

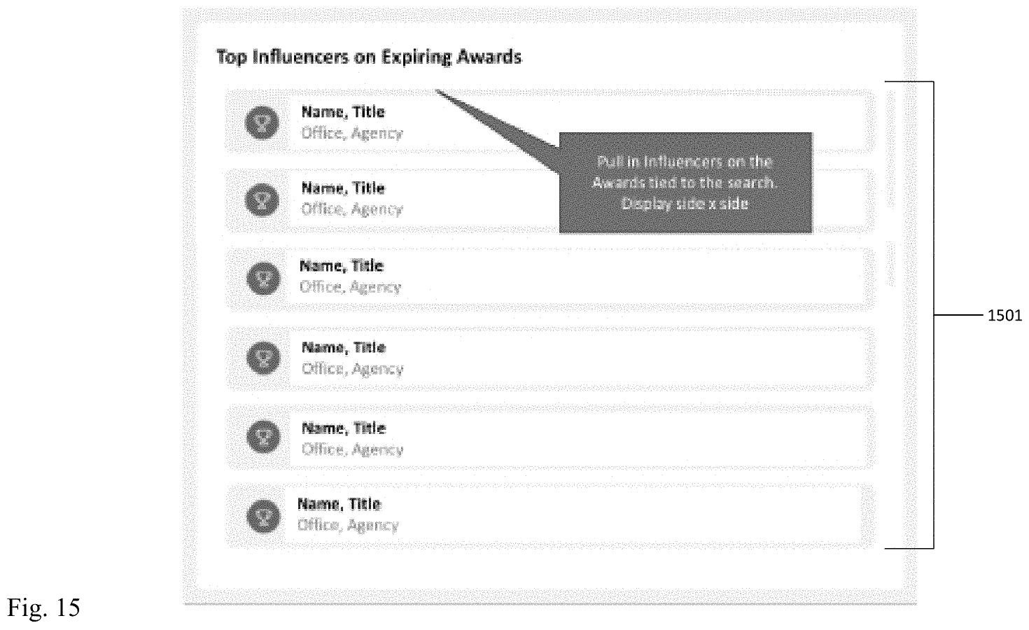

With reference to FIG. 14, expiring award search cards can support nested search (e.g., via UI text field 1401). Such nested search can allow for filtering on the awards domain. Further, such nested search can allow for filtering by award expiration date. For example, the card can display awards which expire within a given time period (e.g., within the next six months). In some embodiments, a default display of the expiring award search card can show a given quantity (e.g., five) (1403) of the awards which are closest to expiring (e.g., based on applied filtering and/or entered search terms). In some embodiments, the expiring award search card can implement a keyword text entry field and a list of opportunities as selectable areas. Additionally, the expiring award search card can, in a manner analogous to that discussed above in connection with the new opportunity search card, allow the user to select a displayed expiring award (with the user receiving additional information about the award in reply), or indicate a desire to view all expiring awards (with the user being transported from the dashboard to a regular search result page). Turning to FIG. 15, as referenced by the callout thereof the expiring award search card can display (1501) top influencers (e.g., awarding office federal workers, or other federal workers) for returned expiring awards.

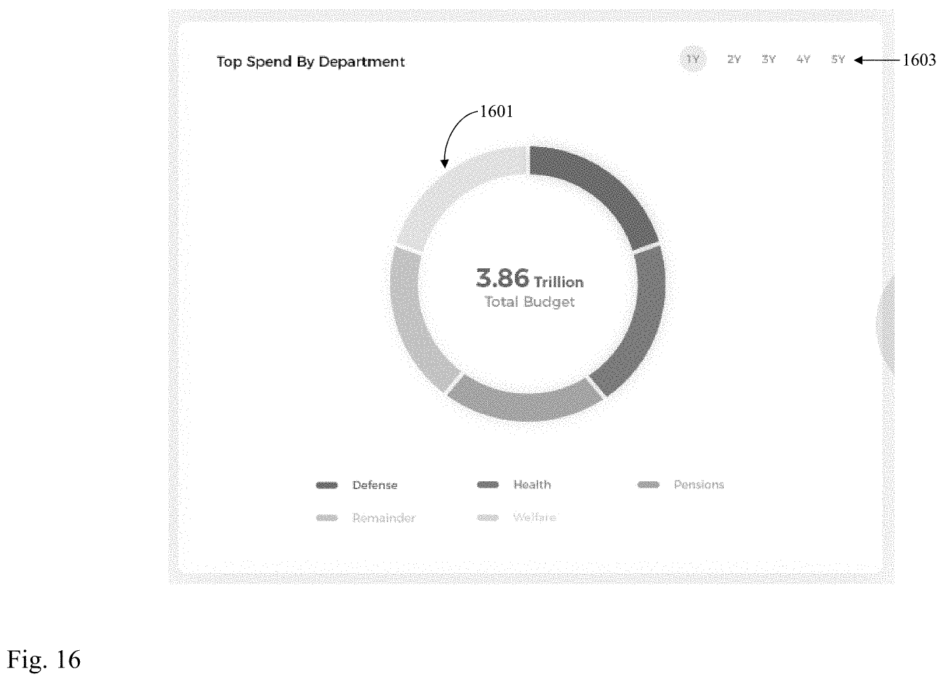

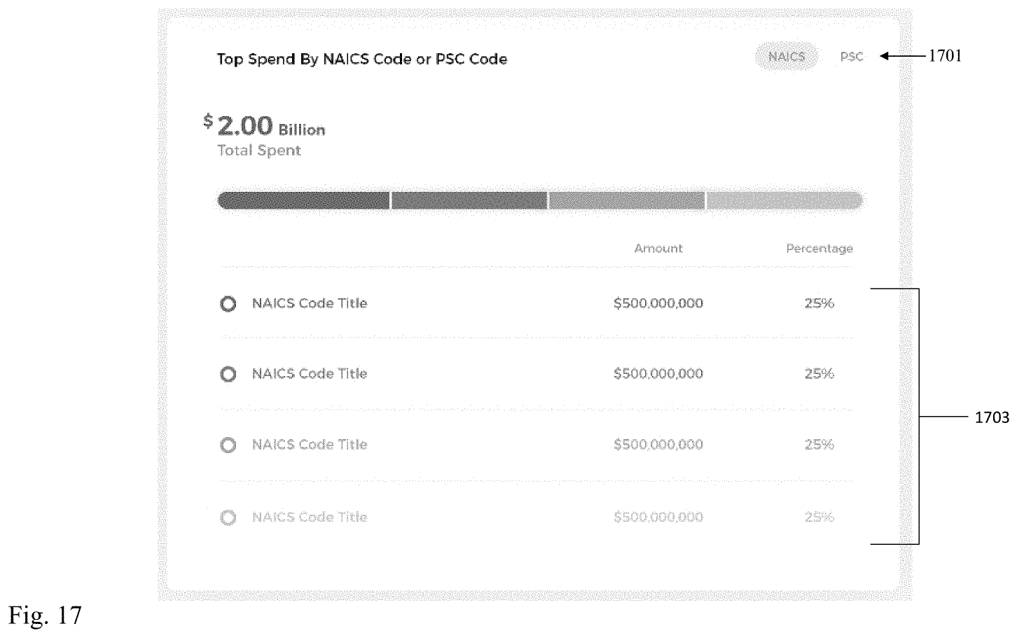

Further, the system can display various informational widgets via the dashboard. The informational widgets displayed by the dashboard can include a top spend by department informational widget, a top spend by NAICS/Product Service Code (PSC) informational widget, a top awardees informational widget, and an awards by state informational widget. With reference to FIG. 16, the top spend by department informational widget can utilize a wheel chart UI element (or other UI element) 1601 to display the top spend by a selected federal department, broken down by top codes (e.g., top NAICS codes). The spend by department informational widget can allow users to filter (1603) by a previous number of time units of spend (e.g., by the previous five years of spend). The spend by department informational widget can further allow users to select a specific federal department that they wish to view. In some embodiments, the user can select using a specified organization type (e.g., all main organizations tagged with a specified tag, or all main organizations satisfying a specified filter). As just one example, the wheel chart (or other utilized UI element) 1601 can show spend for: 1) DoD; 2) DHS; 3) VA; 4) State Department; 5) Treasury Department; 6) Department of Agriculture; 7) Department of Health and Human Services (HHS); and 8) all others. In some embodiments, the widget can be implemented such that there is a default department selection (e.g., the DOD). With reference to FIG. 17, the top spend by NAICS/PSC informational widget can contain a toggle 1701 between NAICS/PSC tags. Also, the widget can allow a user to specify a quantity of years for which the widget should break down spend. For example, the widget can allow the user to break down spend over the past five years, but default to breaking down spend over the past year. As just one example, a 1Y/5Y selector can be nested within the widget under a NAICS/PSC selector of the widget. Also, in operating the widget the system can load a given quantity of top codes (e.g., the top 50 codes), with a given quantity (e.g., five) codes being initially displayed (1703). In displaying codes, the widget can order codes from most spend to least spend, or vice versa. The widget can allow the user to scroll through the code list, and view the codes (e.g., in descending order by most spend). When the user selects a given code, the user can be taken to a search results page. Although NAICS codes and PSC codes are discussed in connection with this and other informational widgets, in various embodiments other codes can also be used.

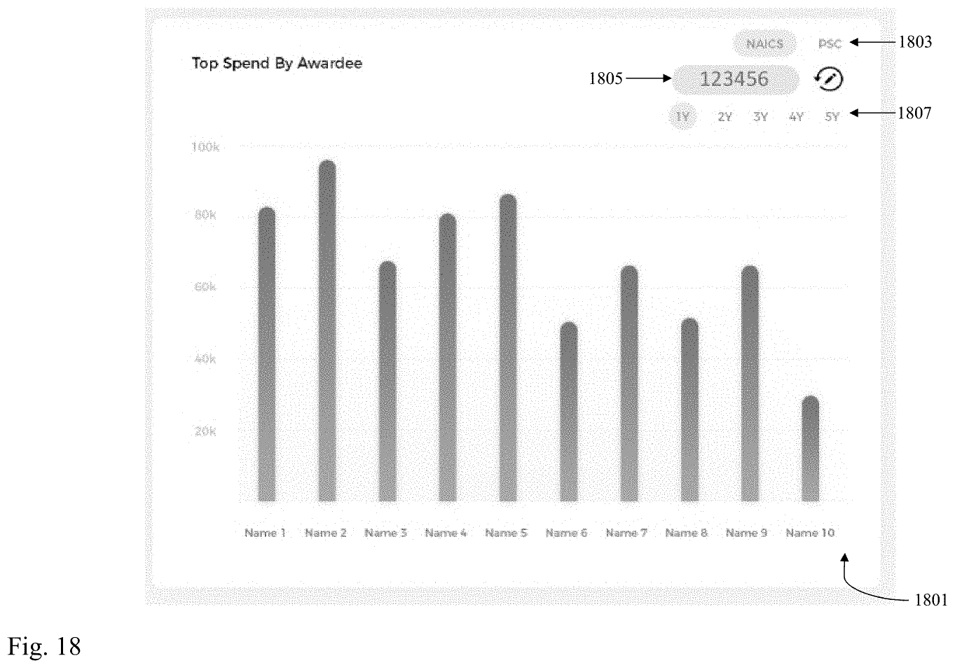

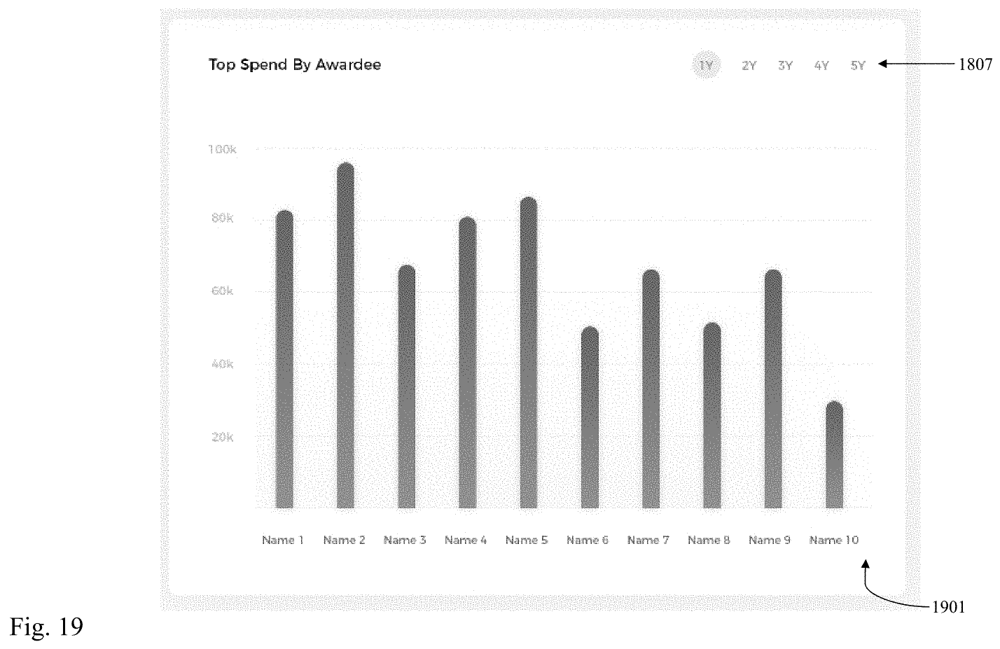

With reference to FIGS. 18 and 19, the top awardees informational widget can include a graph (or other UI element) 1801/1901 showing the top awardees in various areas and/or for various time frames. Also, the widget can, like the previous widget, allow the user to toggle (e.g., using a UI toggle 1803 located in the upper right-hand corner of the widget) between NAICS/PSC tags, and to break down spend over a specified quantity of years (e.g., the past five years). The widget can provide a UI text field 1805 employable by the user to enter an NAICS or PSC code. In some embodiments, the text field 1805 can default to a given NAICS/PSC code. Also, the widget can provide a UI element 1807 which allows the user to specify the quantity of years for which they desire to receive spend breakdown. As reflected by the example vendor names (Name 1, Name 2, etc.) of FIGS. 18 and 19, the widget can indicate award amount for a given quantity of vendors (e.g., 10 vendors). Also, the widget can allow the user to see which vendors won the most awards for a certain user-specified NAICS/PSC area, over a user-selected time frame.

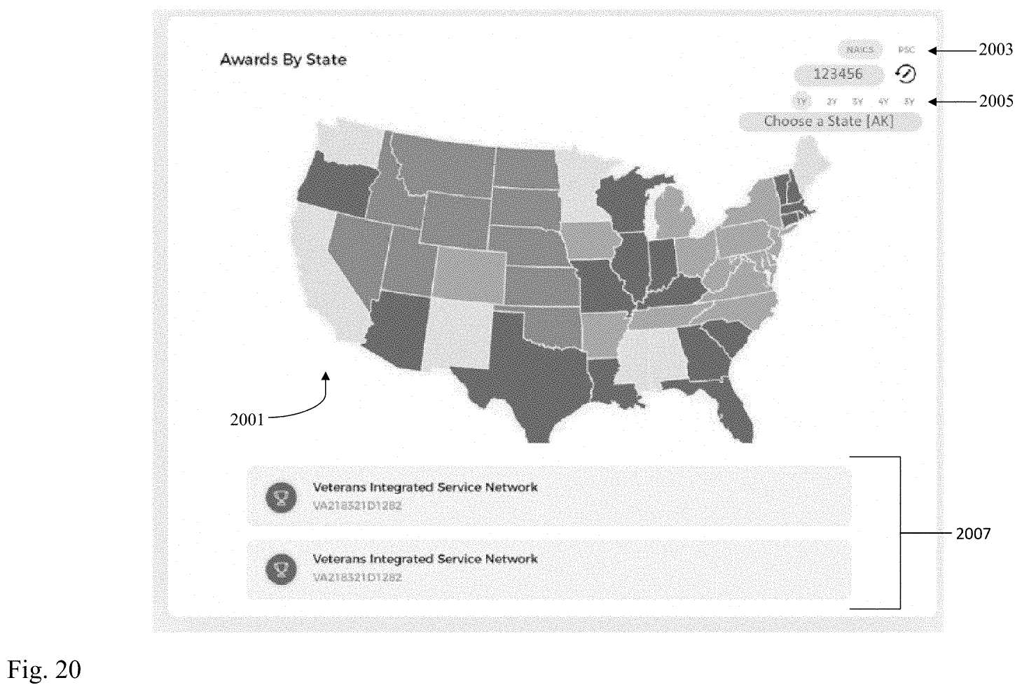

With reference to FIG. 20, the awards by state informational widget can provide a state-by-state map 2001 of the US which allows the user to pick (e.g., using a touchscreen or mouse for selection) individual state(s) for which award information is desired. The widget can include multi-select functionality allowing the user to select multiple state, and/or can allow the user to narrow by NAICS/PSC code and/or by date range. Further, the widget can allow the user to filter by award size. Like the previously discussed widgets, the awards by state informational widget can allow the user to toggle (e.g., using a UI toggle 2003 located in the upper right-hand corner of the widget) between NAICS/PSC tags, and to break down spend over a specified quantity of years (e.g., the past five years). Also, analogous to previously discussed widgets, the awards by state informational widget can provide a UI element 2005 which allows the user to specify the quantity of years for which they desire to receive by-state award information. The widget can display (2007) a given quantity of the awards (e.g., two or three awards), and can allow the user to scroll through the remainder of the awards (e.g., with the widget allowing the user to view a maximum quantity of awards, for instance 20 awards). The widget functionality and other functionality of the dashboard can allow for user personalization. As just some examples, the dashboard can allow for user personalization based on: a) agency and office; b) NAICS/PSC code (or other code); c) size (e.g., award size); and/or awardee (e.g., allowing the user to track competitors).

Although the dashboard functionality has generally been discussed in connection with a UI, other possibilities exist. For example, the dashboard functionality (as well as other functionality discussed herein in connection with a UI) can be made available via an API (e.g., via search API 139, or another API).

### Alerting

The user can be too busy and/or lack the technical resources to monitor those changes that are potentially important to them. As such, the system can utilize the operations discussed above to proactively let federal spend users know where there is a change important to them. The alerting functionality can allow the user to, via a UI, request highly customizable alerts. Also, alerts can be set up by on behalf of the user by staff members associated with the system (e.g., staff members of a company implementing the system). The alerts can include alerts regarding people (e.g., federal employees) and alerts regarding federal spending. The alerts can, as just some examples, be based on saved searches (e.g., allowing the user to request an alert which tracks the results of a search and/or utilizes the input criteria of the search), or saved contact lists. The alerting functionality can go beyond conventional approaches to alerting. As just an example, such conventional approaches are often limited to mere notifications of arrivals/departures across communities (e.g., departure of a federal employee). As just another example, such conventional approaches tend to be limited as to the criteria on which alerts can be based (e.g., according to conventional approaches, the physical locations of people to be tracked cannot be selected). Further, conventional approaches often do not allow users to set up alerts on their own. In various embodiments, implementation of the alerting functionality discussed herein can target one or more user personas. As just some examples, the user personas can include those discussed above in connection with the dashboard (i.e., the personas of BD user, capture team lead, and data miner).

The alerts regarding people—which can be termed “people intelligence briefings”—can be requested by the user using any relevant combination of criteria. As just one example, such criteria can be ones drawn from a people domain of a webpage or web app. Further, the user can specify that a search and corresponding filters be used as the basis for generating an alert. As just some examples, such a search can be a search currently being performed by the user, a saved search, or the URL of a search. The alerts can be generated based on criteria/codes including but not limited to: a) job function; b) job subject; c) people ID; d) organization type; e) organization subject; and f) organization ID. These criteria/codes can be selectable by the user via a UI (in connection with searching and/or via a UI for requesting an alert). Also, in some embodiments these criteria/codes can correspond to backend codes used by the system. Additionally, other filters (or criteria/codes) such as location, education, and member criteria can be specified when requesting notifications.

The alerts regarding federal spending—which can be termed fedspend briefings—can allow for tracking via various criteria. As just some examples, such functionality can allow for alerts which track one or more of: a) NAICS/PSC code (or other code); b) keyword; c) office (agency/department), or group; and d) vendor. Regarding tracking by NAICS/PSC code (or other code), the system can allow the user to use a code (e.g., a six-digit NAICS code) to find solicitations and contracts in their field of interest. Further, the system can allow for the selection of one or multiple codes (e.g., NAICS codes), thereby helping customize alerting. Regarding tracking by keyword, the system can allow the user to track opportunities/awards based on specific keywords included in the title, description, and throughout the data surrounding the opportunity/award. As an illustrative example of just one benefit of such functionality, “cloud” is a common keyword associated with opportunities/awards in technology. However, there is no “cloud” NAICS or PSC tag. Instead, “cloud” opportunities (and subsequent awards) are often placed in different NAICS/PSC categories, depending on the volition of the particular contract personnel individual (e.g., a federal employee) who enters the information, and/or what department they are part of As such, by allowing the user to be able to search, for instance, the title and body of an opportunity/award for terms like “cloud,” the user can be alerted by the system on those opportunities/awards when the relevant term appears.

Regarding tracking opportunities/awards based on office (agency/department), or group, it is noted that user sales territories can vary, based on the size and sophistication of the sales team. For example, one user can be an employee of a company/organization which has 25 employees on its federal sales teams. Continuing with example, this company/organization, having a large federal sales team, can break up all federal departments and independent agencies at the bureau/office level, such that, for instance, one user is responsible for selling to the IRS, and another user is responsible for selling to the Bureau of the Fiscal Service, despite the fact that both are part of the Department of the Treasury. On the other hand, as another example, another user can be an employee of a company/organization which has a small federal sales team with only a few members. Continuing with the example, this company/organization, having a small federal sales team can break up user responsibilities according to civilian agencies versus non-civilian agencies.

To support these and other user scenarios, the system can allow the user to select alerts based on department/agency name filters, organization group filters, and location filters. Using the department/agency name filter, the user can select one or many specific offices via the filter, and be alerted when that department/agency solicits a new opportunity or awards a contract. Using the organization group filter, the user can select from existing organization groups. In this way the user can be alerted when a new opportunity is posted, for example, to any civilian agency (or, in the alternative, to any non-civilian agency). Then, regarding tracking opportunities/awards based on vendor, the system can allow the user to select alerts based on a vendor specified by the user, such as a vendor who is a competitor of the user. This functionality of the system can prove beneficial, for instance, because a user tracking the activities of companies in their space/competitors can prove a highly efficient way of finding relevant offices, awards, and opportunities. As just an illustration, under circumstances where NAICS/PSC and/or keywords generate noise, alerts based on the user's competitors (e.g., direct competitors) can prove helpful, as these competitors are likely selling into the exact spaces most important to the user. As an illustration, a user can use filters such as those noted to request alerts for VA opportunities/awards corresponding to a specific office in a specific location. According to this illustration, the user can receive notification of a useful/manageable quantity of opportunities/awards, such as several per month. Further according to this illustration, if in contrast the user received alert of any VA opportunity/award, the user could be overwhelmed with notification of thousands of opportunities/awards per week.

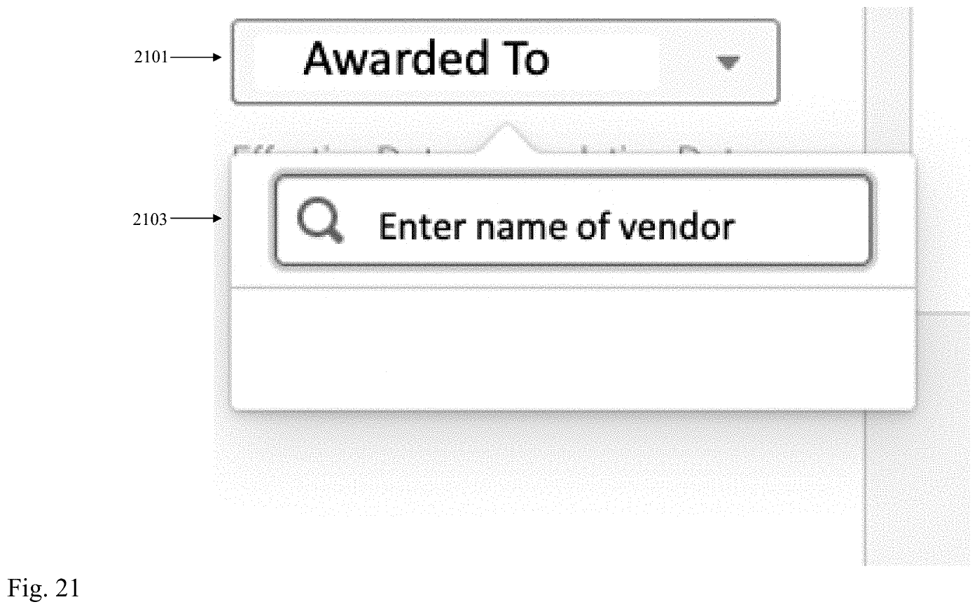

With reference to FIG. 21, in some embodiments the track-by-vendor functionality can allow the user to (e.g., via UI elements 2101 and 2103) specify a name of a vendor, and receive an alert when that vendor is granted an award. According to one implementation, such functionality can make use of vendor name information gathered by the system from contract data. According to another implementation, such functionality can make use of mappings, made by the system, between contractors/vendors (e.g., major contractors/vendors) and the federal staff organizational data. Via the awarded-to functionality, the user can search using terms within a filter, and choose the vendor or vendors that they need. Also, the track by vendor functionality can utilize federal government Unique Entity Identifies (UEIs) which correspond to vendors.

The system can implement various approaches as to when alerts are to be delivered to the user. For example, the system can allow the user to choose between weekly and daily delivery for a given alert desired by the user. The alerts which are delivered weekly can: a) be delivered in one email (e.g., similar to people intel briefings); b) show a maximum quantity of results (e.g., three-five results) per selection; and/or c) after top results, provide a link to “view full results” via a UI (e.g., of a web site or app), allowing the user to see the full results. The alerts which are delivered weekly can show more details than the weekly-delivered alerts, for instance displaying exact changes on an opportunity/contract. In some embodiments the system can suggest to the user (or employ as default functionality) weekly delivery for alerts based on saved searches, and daily delivery for alerts which track specific opportunities or awards.

According to a first example alerting functionality, the system can aid the user in finding opportunities. This alerting functionality can, as just one example, be applicable to a scenario where the user wants to make sure that they are alerted when new potential opportunities arise. Here, the user can utilize a UI offered by the system to provide the system with various information describing the opportunities that should trigger alerts. In response, the system can generate alerts (e.g., weekly briefings) that focus on providing useful results, without overwhelming the user (e.g., with a multitude of emails). In terms of frequency, the first example alerting functionality can, as noted, provide weekly briefings. In terms of criteria selection, as one example the user can select the criteria (e.g., via an advanced search interface or other UI provided by the system). As another example, the criteria can be selected by staff members associated with the system. In terms of when alerts are generated, an alert can be generated when a new opportunity is added. In terms of criteria options for selection, such criteria can include: a) target department/agency; b) NAICS code (or other code); c) keyword; and d) type. As to information that the alert can include, such information can include one or more of: a) name of opportunity (e.g., including a link to open opportunity webpage, app, or other UI); b) NAICS code (or other code); c) type; d) funding office links (when available); e) notice ID; f) description (e.g., preview of text and/or link to open in webpage, app, or other UI); g) date posted; and h) suggested contacts (e.g., federal employees determined by the system to be relevant to the opportunity).

According to a second example of alerting functionality, the system can aid the user in being updated when new contracts are awarded to a user-specified entity (e.g., vendor) and/or by a user-specified entity (e.g., federal department or agency). This alerting functionality can, as just one example, be applicable to a scenario where the user wants to be updated when organizations (e.g., federal departments or agencies) that they care about award new contracts, or when companies/vendors, that they track for competitive and/or partnership purposes, are awarded new contracts. In terms of frequency, the second example alerting functionality can, as just one example, provide weekly briefings. In terms of criteria selection, as one example the user can select the criteria. As another example, the criteria can be selected by staff members associated with the system. As to when award is included in an alert, an award can be included in an alert when: a) the award is a new award added by an entity (e.g., office/agency/department) that the user is tracking; and b) the award is a new award assigned to an entity (e.g., vendor) that the user is tracking. In terms of criteria options for selection, such criteria can include: a) target department/agency; b) NAICS code (or other code); c) keyword; and d) company/vendor. As to information that the alert can include, such information can include one or more of: a) funding office, parent office, main office, and/or other links; b) awarding office; c) recipient (e.g., vendor) name; d) type; e) link to parent Indefinite Delivery Vehicle (IDV), if applicable; f) award ID; g) value of award; h) period of performance and/or award end date; and i) suggested contacts (e.g., federal employees determined by the system to be relevant to the contract/award).

According to a third example of alerting functionality, the system can aid the user in being updated about potential recompete opportunities. This alerting functionality can, as just one example, be applicable to a scenario where it is recognized by the user (e.g., due to the system having suggested such to the user via a UI) that an effective way to win business is to take over an existing contract. According to this example scenario the user can, by using the system to track contracts, be informed when certain agencies or vendors are a given period of time (e.g., six months) away from the end of their contract period. As such the user can, in response to receipt of a corresponding alert issued by the system, prepare to win the contract when it is put up for bid once again. In terms of frequency, the third example alerting functionality can, as just one example, provide weekly briefings. In terms of criteria selection, as one example the user can select the criteria. As another example, the criteria can be selected by staff members associated with the system. As to when award is included in an alert, an award can be included in an alert a given period of time (e.g., six months) prior to a corresponding performance end date. The criteria options for selection and the information that the alert can include can be as discussed in connection with the second example of alerting functionality.

According to a fourth example of alerting functionality, the system can aid the user in being updated on an opportunity that they are tracking. This alerting functionality can, as just one example, be applicable to a scenario where the user finds that they often come across interesting opportunities when browsing opportunities (e.g., via the system). According to this example scenario the user can desire that, rather than continually returning to those opportunities (e.g., via the system, such as via corresponding opportunity pages hosted by the system), the system update them when there is movement on these opportunities. Further according to this example scenario, the user can utilize a UI of the system to indicate/flag such opportunities to the system. Subsequently, the system can track the opportunities for the user and alert the user. In terms of frequency, the fourth example alerting functionality can, as just one example, provide daily briefings. In terms of criteria selection, the user can use a UI of the system to select a specific opportunity or award. In terms of when alerts are generated, an alert can be generated upon a) a status change; b) a relevant notice being added; and/or c) a relevant opportunity due date approaching (e.g., 30 days and/or 7 days). As to information that the alert can include, such information can include one or more of: a) opportunity/contract name; b) highlighted change; c) funding office, parent office, main office, and/or other links; d) notice ID; e) description (e.g., preview thereof); and f) suggested contacts.

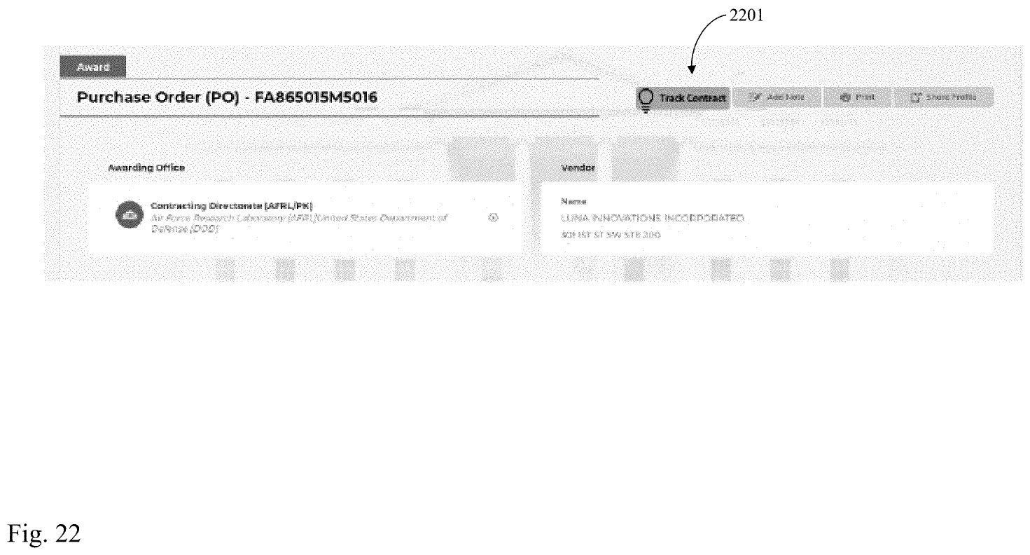

With reference to FIG. 22, according to a fifth example of alerting functionality the system can aid the user in being updated on a contract that they are tracking. This alerting functionality can, as just one example, be applicable to a scenario where the user finds that they often come across interesting contracts/awards when browsing contracts/awards (e.g., via the system). According to this example scenario the user can desire that, rather than continually returning to those contracts/awards (e.g., via the system, such as via corresponding contract/award hosted by the system), the system update them when there is movement on these contracts/awards. Further according to this example scenario, the user can utilize a UI of the system to (e.g., via UI element 2201) indicate/flag such contracts/awards to the system. Subsequently, the system can track the contracts/awards for the user and alert the user. In terms of frequency, the fifth example alerting functionality can, as just one example, provide daily briefings. In terms of criteria selection, the user can use a UI of the system to select a specific contract/award. In terms of when alerts are generated, an alert can be generated upon a) a contract/award notice being added; b) a contract/award update; c) a contract/award modification; d) a contract/award performance date ending within a given period of time (e.g., six months); and/or e) a contract/award expiring. As to information that the alert can include, such information can include one or more of: a) contract/award name; b) highlighted change; c) funding office, parent office, main office, and/or other links; d) contract/award type; e) link to parent IDV, if applicable; f) a new child contract/award being added to a corresponding parent IDV, if applicable; g) notice ID; e) period of performance and/or award end date; and f) suggested contacts.

As referenced, the system can show suggested contacts in alerts. By listing relevant contacts in alerts provided by a UI of the system, the system can help users. As just one example, the system can determine people (e.g., federal employees) who are working at the funding office of the opportunity/award of a given alert, and who are focused on the areas important to the user (e.g., based on inputs provided to the system via a UI and/or based on determinations made by the system), to be important contacts (e.g., most important contacts). As to when contacts are generated by the system, as just one example the system can generate contacts when an alert is generated for an opportunity/award that is mapped to a funding office at an organization (e.g., a live organization). Here, the system can display corresponding “Suggested Contacts” in the alert. In some embodiments, the system can display a maximum quantity of contacts (e.g., two contacts) per opportunity/award. Also, in some embodiments the system can, as just one example, show contacts based on the following criteria, in order of priority: 1) contacts that include job title=program manager; 2) contacts that include job title=c-suite; 3) contacts that tagged as appointed officials; and 4) the first sequenced contact at the organization.

The user, and/or staff members associated with the system, can use a UI of the system (e.g., an advanced search interface of a web app) to select alerting criteria on their own (e.g., rather than requesting alerts from a development team). For example, such staff members can be able to login as users using an admin portal, and set up alerts for users. Further, the system can allow the user to be able to save their own searches and contacts list as alerts. Also, as just an example, when an alert request is made, it can be added at the account level of the user that created the request (or the user on behalf of whom the request was made), and/or can be assigned as active to that user. Further, the system can allow system staff members to, at any time, assign a given alert to any user on the relevant account, using the admin portal.

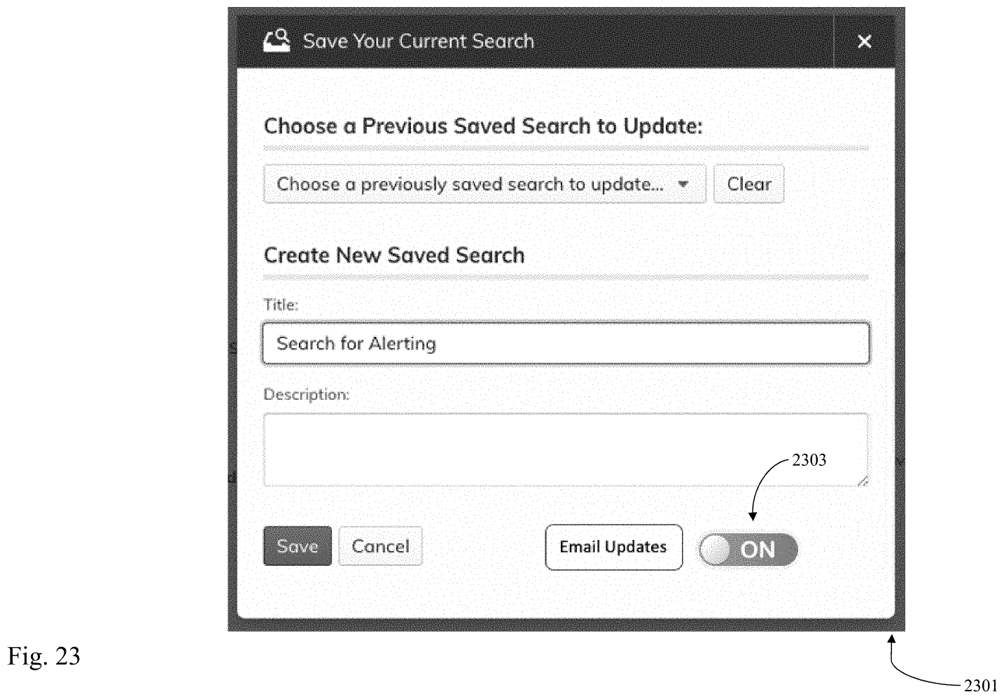

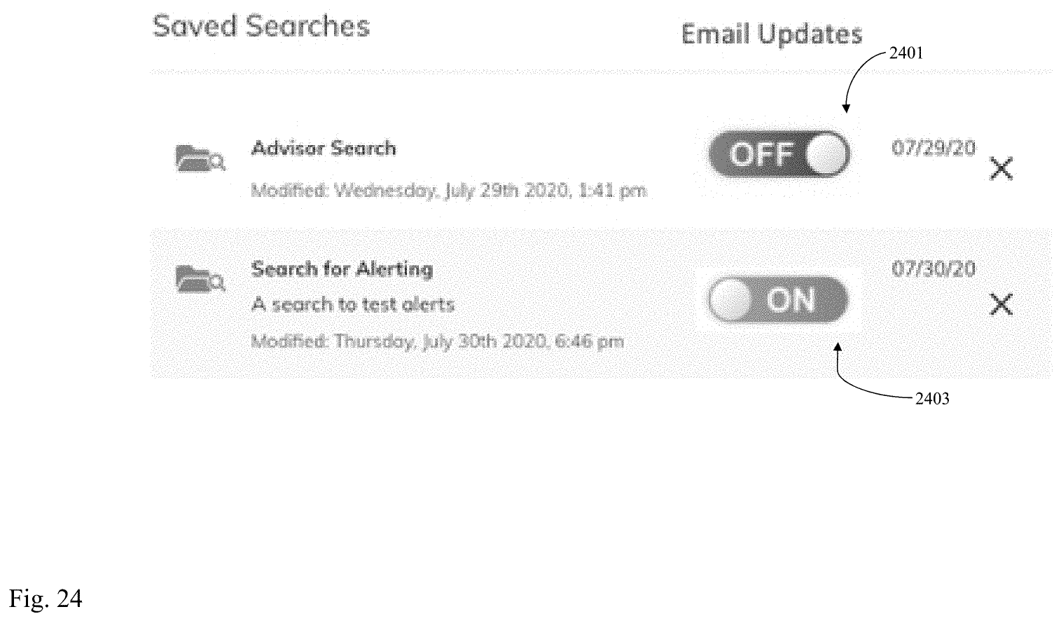

With reference to FIG. 23 and FIG. 24, the system can provide saved search functionality. Here, the system can allow the user to utilize a UI of the system to build a search using, for example, people filters. Upon saving the list, the user can be prompted (2301) to additionally save the list for alerting. The user can use a UI of the system to choose (e.g., via UI element 2303) to be regularly alerted to these changes, or not to be. With reference to FIG. 24, a user profile UI (or other UI) of the system can include, for each saved search, a toggle for “Email Briefing On/Off.” The user can at (e.g., any time) choose to turn on or off notifications for specific saved searches (e.g., via UI elements 2401 and 2403).

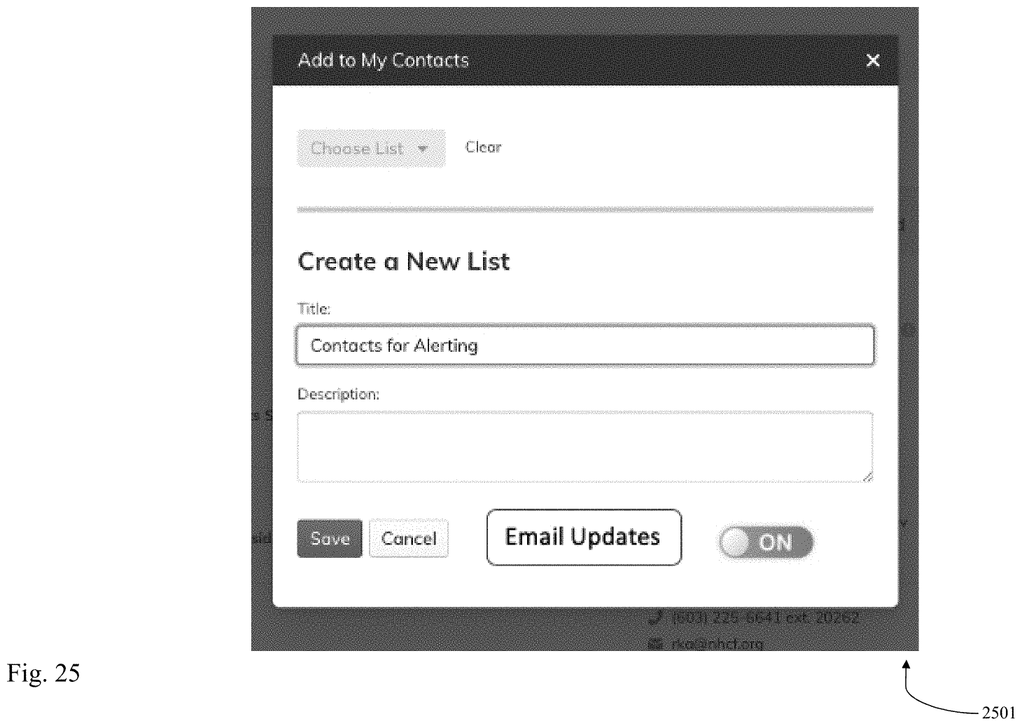

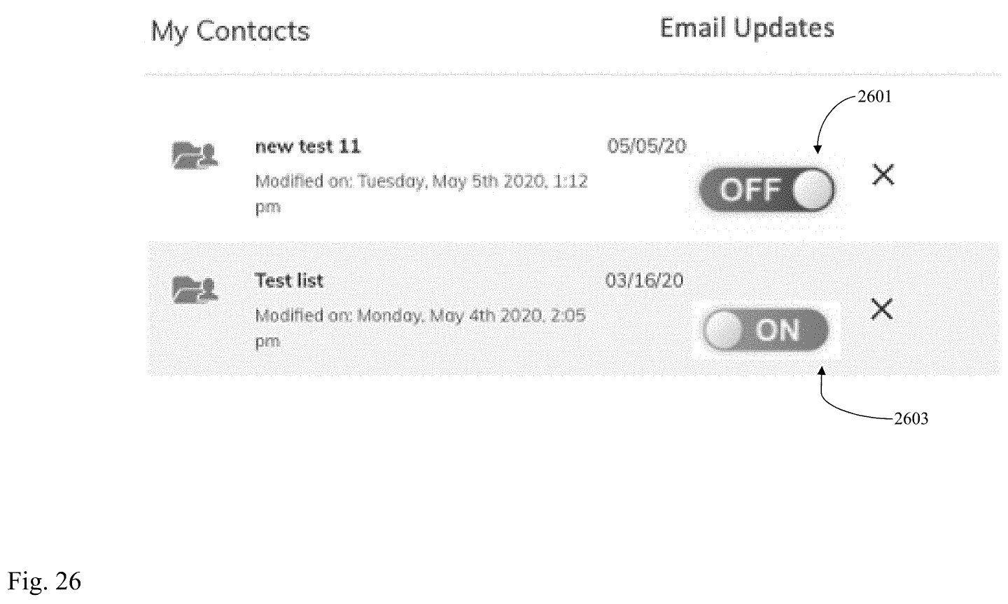

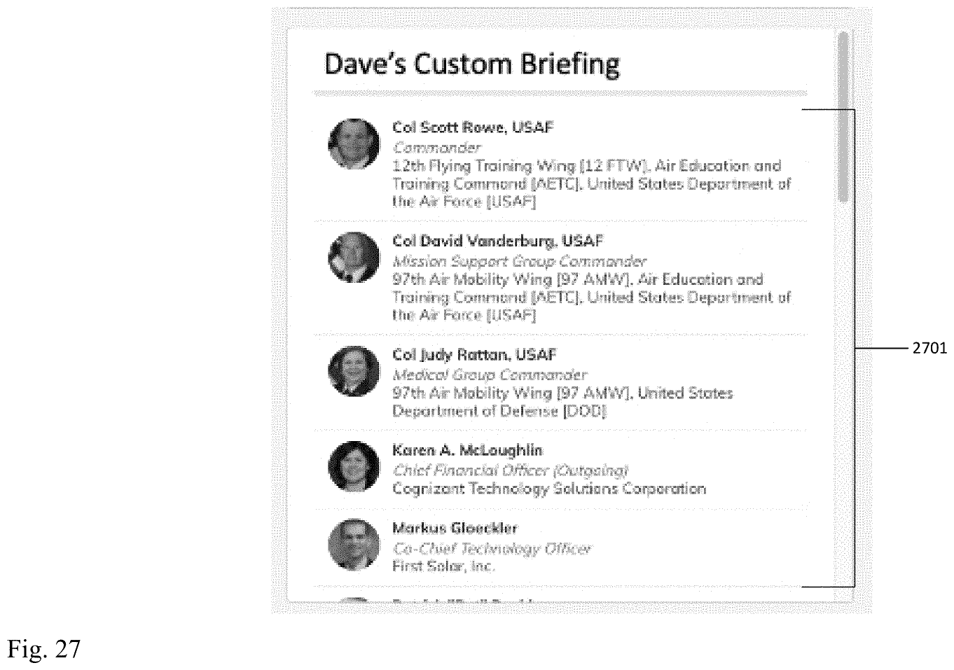

With reference to FIG. 25, FIG. 26, and FIG. 27, the system can provide contacts list functionality. Here, subsequent to the user having created their own custom contacts list, the user can, upon saving the list, be prompted (2501) to additionally save the list for alerting. The criteria for the briefing/alert can, as an example, be some or all of the people in the user's contacts list (e.g., via unique PeopleIDs in the user's contacts list). With reference to FIG. 26, a user profile UI (or other UI) of the system can show, for each contacts list, an “Email Briefing On/Off” UI toggle. Using this UI the user can (e.g., at any time) choose to turn on or off notifications for specific contacts lists (e.g., via UI elements 2601 and 2603). Turning to FIG. 27, the system can provide a dashboard informational widget regarding the contacts list functionality. This informational widget can allow the user to stay updated on changes to their selections (e.g., whenever they log into the system). As an example, subsequent to the user having requested alerts/notifications, the system can add a new dashboard informational widget based on the customized selections of the user. In this way, the user can (e.g., whenever they log in), see updates (2701) on the contacts that they care about (e.g., rather than merely via email).

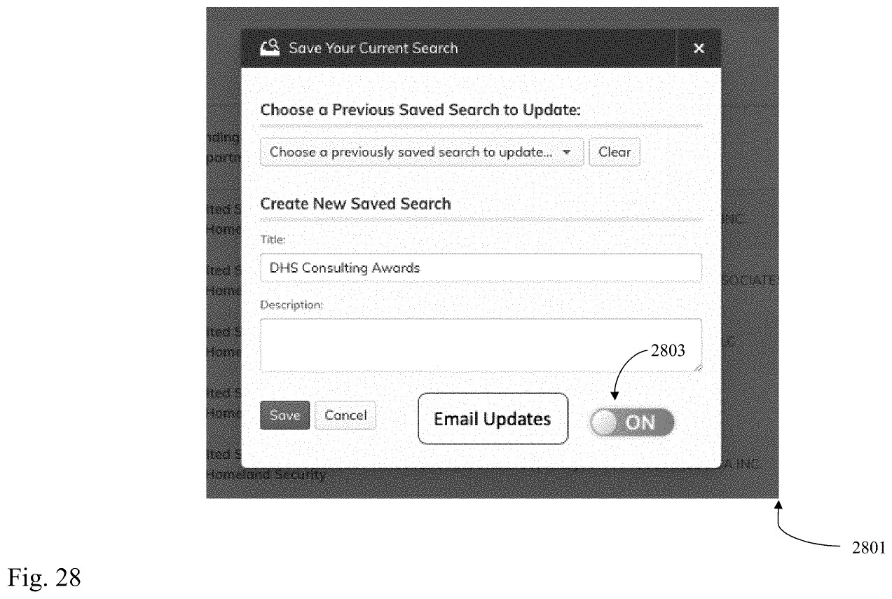

With reference to FIG. 28, as referenced the user can utilize a UI of the system (e.g., an advanced search filter UI) to build lists based off awards and opportunities. Subsequent to saving a list, the user can be prompted (2801) to additionally save the list for alerting. The user can use a UI of the system to choose (e.g., via UI element 2803) to be regularly alerted to relevant changes, or not. Further, the system can provide a dashboard informational widget regarding such awards/opportunities-based functionality. This informational widget can allow the user to stay updated on changes to their selections (e.g., whenever they log into the system). As an example, subsequent to the user having requested alerts/notifications, the system can add a new dashboard informational widget that shows only results relevant to the selections the user has created.

Although the alerting functionality has generally been discussed in connection with a UI, other possibilities exist. For example, the alerting functionality (as well as other functionality discussed herein in connection with a UI) can be made available via an API (e.g., via search API 139, or another API).

### Hardware and Software

According to various embodiments, various functionality discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

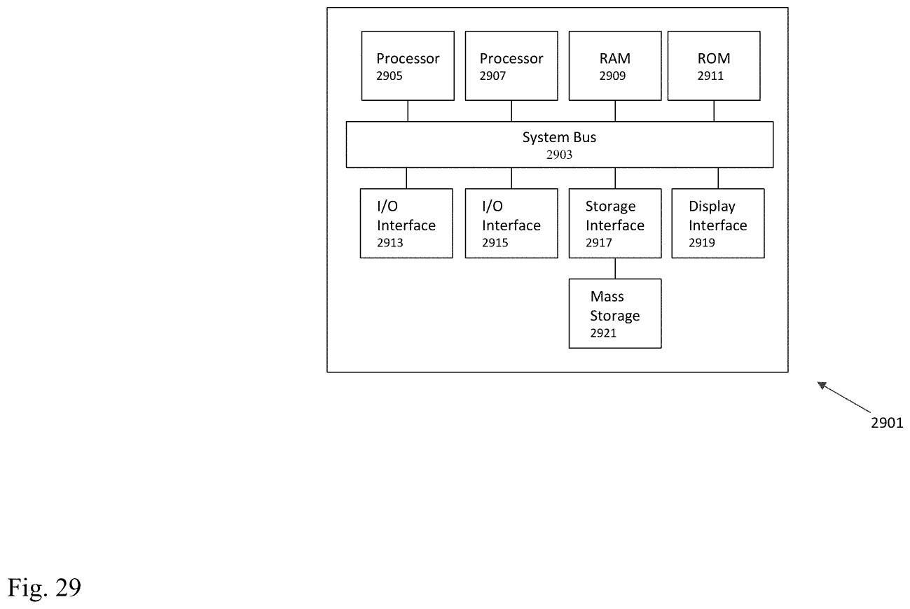

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 29 is an example computer employable in various embodiments of the present invention. Exemplary computer 2901 includes system bus 2903 which operatively connects two processors 2905 and 2907, random access memory (RAM) 2909, read-only memory (ROM) 2911, input output (I/O) interfaces 2913 and 2915, storage interface 2917, and display interface 2919. Storage interface 2917 in turn connects to mass storage 2921. Each of I/O interfaces 2913 and 2915 can, as just some examples, be a Universal Serial Bus (USB), a Thunderbolt, an Ethernet, a Bluetooth, a Long Term Evolution (LTE), a 5G, an IEEE 488, and/or other interface. Mass storage 2921 can be a flash drive, a hard drive, an optical drive, or a memory chip, as just some possibilities. Processors 2905 and 2907 can each be, as just some examples, a commonly known processor such as an ARM-based or x86-based processor. Computer 2901 can, in various embodiments, include or be connected to a touch screen, a mouse, and/or a keyboard. Computer 2901 can additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules can, for example, be programmed using Python, Java, JavaScript, Swift, C, C++, C#, and/or another language. Corresponding program code can be placed on media such as, for example, DVD, CD-ROM, memory card, and/or floppy disk. It is noted that any indicated division of operations among particular software modules is for purposes of illustration, and that alternate divisions of operation may be employed. Accordingly, any operations indicated as being performed by one software module can instead be performed by a plurality of software modules. Similarly, any operations indicated as being performed by a plurality of modules can instead be performed by a single module. It is noted that operations indicated as being performed by a particular computer can instead be performed by a plurality of computers. It is further noted that, in various embodiments, peer-to-peer and/or grid computing techniques may be employed. It is additionally noted that, in various embodiments, remote communication among software modules may occur. Such remote communication can, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

### Ramifications and Scope

Although the description above contains many specifics, these are merely provided to illustrate the invention and should not be construed as limitations of the invention's scope. Thus, it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

1. A computer-implemented method, comprising:
receiving, by a computing system from multiple data sources, federal spend data;
augmenting, by the computing system, the received federal spend data;
performing, by the computing system, one or more of contract mapping operations or opportunity mapping operations;
performing, by the computing system, one or more of award linking operations or opportunity linking operations; and
providing, by the computing system, a search interface for searching among data resulting from one or more of said augmenting, said mapping operations, or said linking operations.

2. The computer-implemented method of claim 1, wherein said augmenting includes performing mapping between the received federal spend data and independently-compiled federal staff organizational data.

3. The computer-implemented method of claim 1, wherein said performance of contract mapping operations includes mapping one or more of funding offices or awarding offices to respective federal offices.

4. The computer-implemented method of claim 1, wherein said performance of contract mapping operations includes employing machine learning approaches to determine mappings for one or more missing offices.

5. The computer-implemented method of claim 1, wherein said performance of opportunity mapping operations includes mapping opportunity notices to federal staff organizational data.

6. The computer-implemented method of claim 1, wherein said performance of opportunity mapping operations includes one or more of joining opportunity notices to contracts, or normalizing solicitation numbers and award identifiers.

7. The computer-implemented method of claim 1, wherein said performance of award linking operations comprises processing one or more of awards, modifications, transactions, organizations, terms, or sums.

8. The computer-implemented method of claim 1, wherein said performance of opportunity linking operations comprises processing one or more of opportunities, notices, organizations, or terms.

9. The computer-implemented method of claim 1, further comprising:
updating, by the computing system, one or more of federal spend contracts associated with said augmented federal spend data, or federal opportunity notices associated with said augmented federal spend data.

10. The computer-implemented method of claim 1, further comprising:
tracking, by the computing system, across multiple time periods, modifications of federal spend contracts.

11. A system, comprising:
at least one processor; and
a memory storing instructions that, when executed by the at least one processor, cause the system to perform:
receiving, from multiple data sources, federal spend data;
augmenting the received federal spend data;
performing one or more of contract mapping operations or opportunity mapping operations;
performing one or more of award linking operations or opportunity linking operations; and
providing a search interface for searching among data resulting from one or more of said augmenting, said mapping operations, or said linking operations.

12. The system of claim 11, wherein said performance of contract mapping operations includes mapping one or more of funding offices or awarding offices to respective federal offices.

13. The system of claim 11, wherein said performance of contract mapping operations includes employing machine learning approaches to determine mappings for one or more missing offices.

14. The system of claim 11, wherein said performance of opportunity mapping operations includes mapping opportunity notices to federal staff organizational data.

15. The system of claim 11, wherein said performance of opportunity mapping operations includes one or more of joining opportunity notices to contracts, or normalizing solicitation numbers and award identifiers.

16. A non-transitory computer-readable storage medium including instructions that, when executed by at least one processor of a computing system, cause the computing system to perform a method comprising:
receiving, from multiple data sources, federal spend data;
augmenting the received federal spend data;
performing one or more of contract mapping operations or opportunity mapping operations;
performing one or more of award linking operations or opportunity linking operations; and
providing a search interface for searching among data resulting from one or more of said augmenting, said mapping operations, or said linking operations.

17. The non-transitory computer-readable storage medium of claim 16, wherein said performance of contract mapping operations includes mapping one or more of funding offices or awarding offices to respective federal offices.

18. The non-transitory computer-readable storage medium of claim 16, wherein said performance of contract mapping operations includes employing machine learning approaches to determine mappings for one or more missing offices.

19. The non-transitory computer-readable storage medium of claim 16, wherein said performance of opportunity mapping operations includes mapping opportunity notices to federal staff organizational data.

20. The non-transitory computer-readable storage medium of claim 16, wherein said performance of opportunity mapping operations includes one or more of joining opportunity notices to contracts, or normalizing solicitation numbers and award identifiers.
